(19) United States
(12) Patent Application Publication
(10) Pub. No.: US 2013/0080184 A1
(43) Pub. Date: Mar. 28, 2013

(54) MANAGING HEALTHCARE INFORMATION FOR MEMBERS OF A SOCIAL NETWORK

(71) Applicant: Alliance Health Networks, Inc., Salt Lake City, UT (US)

(72) Inventors: Derek Alan Streat, Seattle, WA (US); James Theodore Bartot, Seattle, WA (US); Talib Sharif, Bellevue, WA (US); David Ballantyne Christianson, Seattle, WA (US); Gunnar Sigurdsson, Seattle, WA (US)

(73) Assignee: Alliance Health Networks, Inc., Salt Lake City, UT (US)

(21) Appl. No.: 13/624,793

(22) Filed: Sep. 21, 2012

Related U.S. Application Data
(60) Provisional application No. 61/538,783, filed on Sep. 23, 2011.

(51) Int. Cl. G06Q 50/22

(52) U.S. Cl. 705/2

(57) ABSTRACT

Embodiments are directed to a healthcare information system (HIS) for supplying patients, caregivers, and their families with the tools and data-driven intelligence needed to achieve greater visibility, management, and control over their loved ones' care. The HIS may enable members to exchange requests for healthcare information between other members. A requesting member may generate a request and forward to other members that may be in a social network. Members that receive the request may subsequently forward the request to still other members. Forwarding requests may improve the chance of finding resolutions. The HIS may track which members received the request and what actions they took. This tracked information is used to generate reports for visualizing how a request flowed through the member community. The tracked information may be analyzed to determine interactions between members and/or social networks.

### CROSS-REFERENCE TO RELATED APPLICATION(S)

This application is a utility patent application based on previously filed U.S. Provisional Patent Application, Ser. No. 61/538,783 filed on Sep. 23, 2011, the benefit of which is hereby claimed under 35 U.S.C. §119(e) and incorporated herein by reference.

### TECHNICAL FIELD

Various embodiments relate generally to collecting, discovering, and managing healthcare information, care and treatment information for patients, friends, families, care-givers, health professionals, researchers, and social networks thereof.

### BACKGROUND

Current solutions available for patients and their loved ones to research the availability and efficacies of health care treatments often generate an overwhelming amount of data from disjoint sources. Because there is so much healthcare information available it is often difficult for laymen and even professionals to discern the relevant healthcare information. Also, for many patients, friends, families, care-givers, health professionals, and researchers if is difficult to identify and communicate with those experiencing similar healthcare related circumstances, or having similar interests therein. Health outcomes and quality of life may be improved by collecting, analyzing, aggregating health care information from multiple sources and presenting it useful and actionable formats. Likewise, communities of people effected by, or interested in specific illnesses, diseases, and treatment thereof can find and communicate with each other by forming related social networks. It is with respect to those considerations and others that the invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Description Of The Various Embodiments, which is to be read in association with the accompanying drawings, wherein:

FIG. 1 illustrates a system environment in which various embodiments may be implemented;

FIG. 2A shows a schematic drawing of a rack of blade servers;

FIG. 2B illustrates a schematic embodiment of a blade server that may be included in a rack of blade servers such as that shown in FIG. 2A;

FIG. 3 shows a schematic embodiment of a mobile device;

FIG. 4 illustrates a schematic embodiment of a network device;

FIG. 5 shows a illustrative logical diagram for collecting healthcare information from various sources and combined with member interactions with further analytic processing to identify insights in accordance with at least one of the various embodiments;

FIG. 6 shows an overview flowchart for a process for collecting healthcare information documents from multiple sources in accordance with at least one of the various embodiments;

FIG. 7 illustrates the extraction of insights from collected healthcare information documents in accordance with at least one of the various embodiments;

FIG. 8 illustrates a representation of historical treatment plans arranged to help a member determine a roadmap for treatment in accordance with at least one of the various embodiments;

FIG. 9 shows a flowchart for a process that enables member patients to create and send requests in accordance with at least one of the various embodiments;

FIG. 10 shows a flowchart for a process for receiving and responding to requests from members in accordance with at least one of the various embodiments; and

FIG. 11 illustrates a social network path to action for a request in accordance with one of the various embodiments.

### DESCRIPTION OF THE VARIOUS EMBODIMENTS

Various embodiments now may be described more folly hereinafter with reference to the accompanying drawings, which form a part hereof and which show, by way of illustration, specific exemplary embodiments that may be practiced. The various embodiments may, however, be embodied in many different forms and should not be construed as limited to the embodiments set forth herein; rather these embodiments are provided so that this disclosure may be thorough and complete and may fully convey the scope of the various embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the various embodiments.

In addition, as used herein, the term “or” is an inclusive “or” operator, and is equivalent to the term “and/or” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on,”

In the description to follow, the term “document” is to be broadly interpreted to include any machine-readable and machine-storable product. A document may include, for example, a web page, word processor files (e.g., MS Word, Word perfect), PDF files, an image file, information relating to treatments, a scanned magazine, a scanned book, a file, a combination of files, one or more files with, embedded links to other files, a blog posting, an e-mail, audio, video, structured data (e.g., XML, CSV, and JSON), unstructured data and the like. Documents may include textual information and may include embedded information such as meta-data, embedded instructions (e.g., macros, vbscript, and javascript), hyperlinks, and the like.

The following briefly describes the embodiments of the invention in order to provide a basic understanding of some aspects of the invention. This brief description is not intended as an extensive overview. It is not intended to identify key or critical, elements, or to delineate or otherwise narrow the scope. Its purpose is merely to present some concepts in a simplified form as a prelude to the more detailed description that is presented later.

As used herein the term “member” refers to an individual user that has registered with a healthcare information system, in at least one of the various embodiments, members may generate profiles that include personal information, interests, or the like. In at least one of the various embodiments, some members may be referred to as users and vice-versa. Likewise, “non-member” as used herein refers to individuals, that are not registered with a given healthcare information system.

As used herein the term “social network” refers to one or more members in a healthcare information system that may be associated with each other. A member may be simultaneously associated with one or more types of social networks that include healthcare information system members. Social networks maybe employed to organize and/or group members. Social networks maybe based on different types of relationships such as, family relationships (e.g., spouse, children, parents, guardians, or the like, care relationships (e.g., healthcare providers, care givers, or the like), interests, locations age, or the like. Social networks may be ranked among themselves based on the number of associated members, the amount of activity generated by associated members, the number of shared members, the strength of the relationships between members, or the like.

In some cases, the healthcare information system may generate temporary social networks that include members targeted for a particular request. In at least one of the various embodiments, temporary social networks may be generated based on filters, searches, groupings, or the like. Temporary social networks may be subsets of other social networks. For example, in at least one of the various embodiments, a temporary social network maybe based on filtering a larger social network such as one that includes members interested in diabetes.

As used herein the term, “healthcare information” refers to information related to healthcare and/or activities associated with healthcare. As further described below, healthcare information may include reference sources, professional journals, research data, or the like. In addition, healthcare information may include information relating to tasks and/or actions that may be relevant to a member that this in involved in a healthcare matter, such as, identifying friends or family who may be available to help with an errand (e.g., scheduling childcare while a parent may in the hospital). In at least one of the various embodiments, the healthcare information system may enable members to generated requests for healthcare information ranging from asking simple questions regarding a treatment to reaching out to find someone that may provide temporary housing for member that may be receiving treatment far from home.

As used herein the terms, “help request,” “healthcare information request,” and “request” refer to a request for information generated by a member for help, or information about a issues, problems, questions, or tasks that may be related to their healthcare issues, healthcare interests, or the like. In at least one of the various embodiments, the healthcare information system may forward requests to other members. In at least one of the various embodiments, the particular members who receive the forwarded requests maybe determined based in part on the social networks and/or preferences of the member that generates the request.

Briefly stated various embodiments are directed to a healthcare information system (HIS) for supplying patients, caregivers, and their families with the tools and data-driven intelligence needed to achieve greater visibility, management, and control over their loved ones' care. In at least one of various embodiments, the HIS may improve access to information and may help members of the HIS to discover insights into how to manage their particular healthcare circumstances.

In at least one of the various embodiments, the HIS may enable members to exchange requests between other members. A requesting member may generate a request for healthcare information and forward to other members that may be in a social network within the healthcare information system. In at least one of the various embodiments, members that receive the request may subsequently forward the request to still other members.

Forwarding the requests may enable the requesting member to find a resolution that otherwise may be unavailable. In at least, one of the various embodiments, the HIS may track which members received the request and what actions they took. The HIS may employ this tracked information to generate reports for visualizing how a request may have flowed through the member community. The tracked information may be analyzed to determine interactions between members and/or the social networks that may be involved in providing resolutions to requests.

In at least one of the various embodiments, the HIS may improve access to healthcare resources and healthcare information that may be trapped within difficult to access systems, such as, paper-based tracking systems, complex risk management and evidence-based decision systems used by insurance companies, hospitals, home care organizations, or the like. In at least one of the various embodiments, members with access to knowledge buried within highly technical literature that only researchers and doctors are trained to interpret. Also, in at least one of the various embodiments, the HIS may provide members with tools that may empower them to discover insights that truly impact care.

### Illustrative Operating Environment

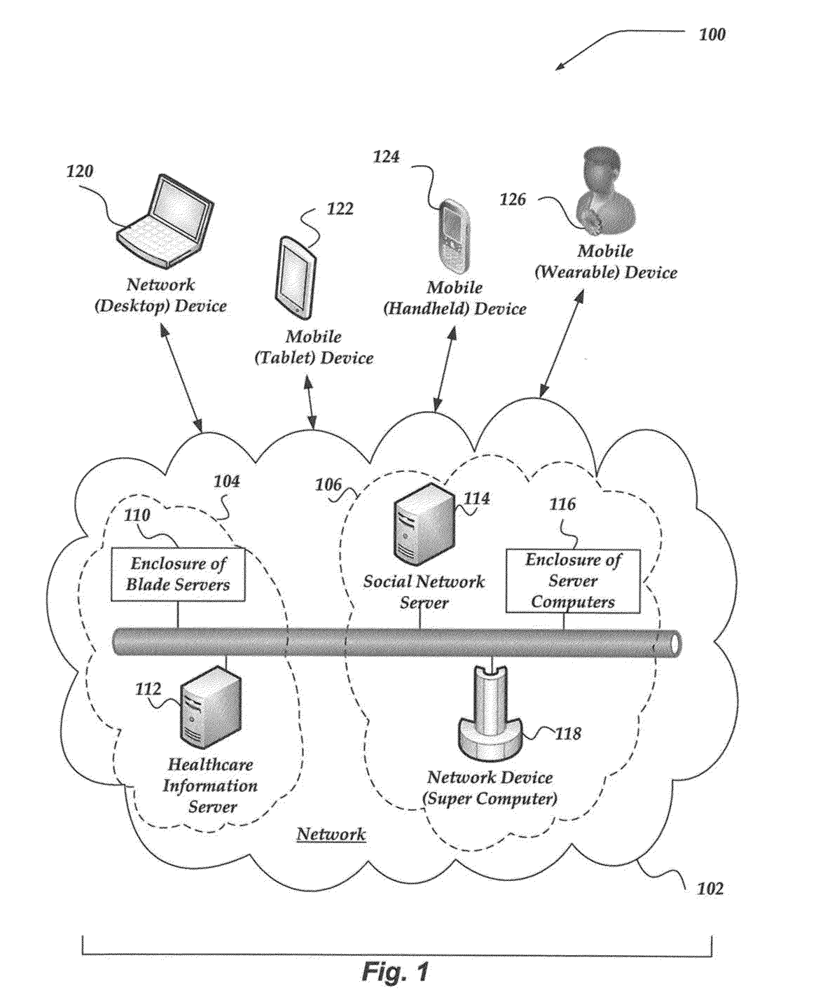

FIG. 1 shows components of an environment in which various embodiments may be practiced. Not all of the components may he required to practice the various embodiments, and variations in the arrangement and type of the components may be made without departing from the spirit or scope of the various embodiments.

In at least one embodiment, cloud network 102 enables one or more network services for a user based on the operation of corresponding arrangements 104 and 106 of virtually any type of networked computing device. As shown, the networked computing devices may include healthcare information server 112, social network server 114, enclosure of blade servers 110, enclosure of server computers 116, super computer network device 118, and the like. Although not shown, one or more mobile devices may be included in cloud network 102 in one or more arrangements to provide one or more network services to a user. Also, these arrangements of networked computing devices may or may not be mutually exclusive of each other.

Additionally, the user may employ a plurality of virtually any type of wired or wireless networked computing devices to communicate with cloud network 102 and access at least one of the network services enabled by one or more of arrangements 104 and 106. These networked computing devices may include tablet mobile device 122, handheld mobile device 124, wearable mobile device 126, desktop network device 120, and the like. Although not shown, in various embodiments, the user may also employ notebook computers, desktop computers, microprocessor-based or programmable consumer electronics, network appliances, mobile telephones, smart telephones, pagers, radio frequency (RF) devices, infrared (IR) devices, Personal Digital Assistants (PDAs), televisions, integrated devices combining at least one of the preceding devices, and the like.

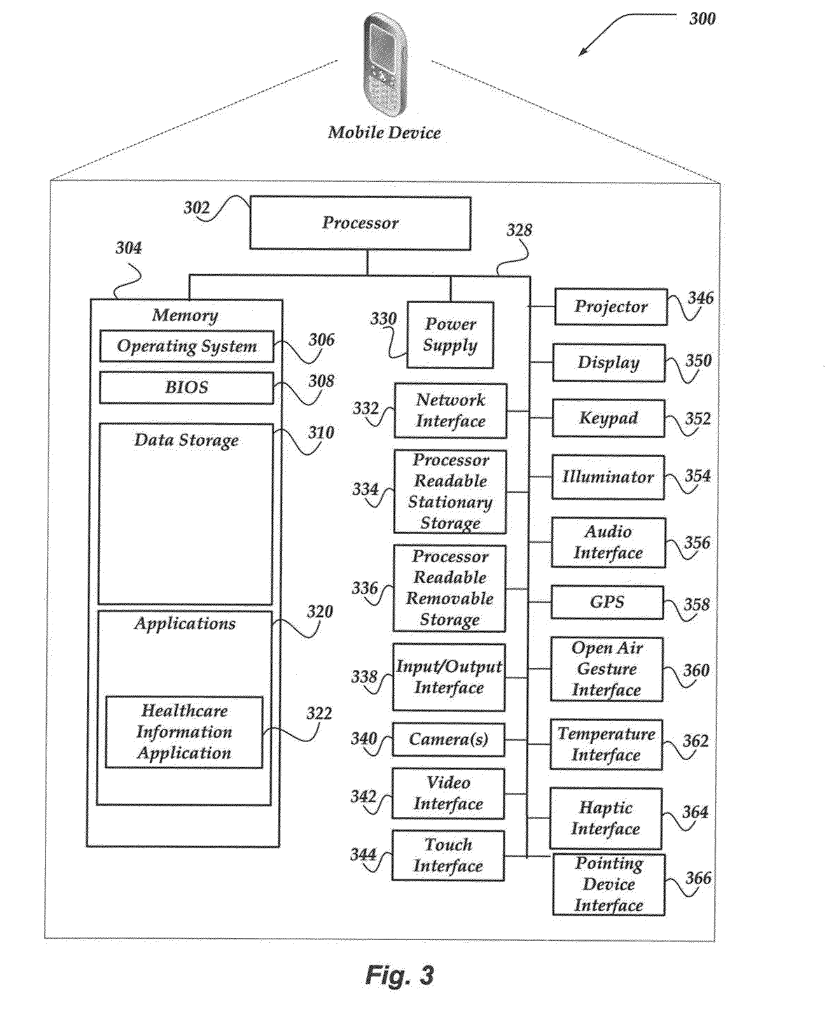

One embodiment of a mobile device is described in more detail below in conjunction with FIG. 3. Generally, mobile devices may include virtually any substantially portable networked computing device capable of communicating over a wired, wireless, or some combination of wired and wireless network.

In various embodiments, network 102 may employ virtually any form of communication technology and topology. For example, network 102 can include local area, networks Personal Area Networks (PANs), (LANs), Campus Area Networks (CANs), Metropolitan Area Networks (MANs) Wide Area Networks (WANs), direct communication connections, and the like, or any combination thereof. On an interconnected set of LANs, including those based on differing architectures and protocols, a router acts as a link between LANs, enabling messages to be sent from one to another. In addition, communication links within, networks may include virtually any type of link, e.g., twisted wire pair lines, optical fibers, open air lasers or coaxial cable, plain old telephone service (POTS), wave guides, acoustic, full or fractional dedicated digital communication lines including T1, T2, T3, and T4, and/or other carrier and other wired media and wireless media. These carrier mechanisms may include E-carriers, Integrated Services Digital Networks ISDNs), universal serial bus (USB) ports, Firewire ports, Thunderbolt ports, Digital Subscriber Lines (DSLs), wireless links including satellite links, or other communications links known, to those skilled in the art. Moreover, these communication links may further employ any of a variety of digital signaling technologies, including without limit, for example, DS-0, DS-1, DS-2, DS-3, DS-4, OC-3, OC-12, OC-48, or the like. Furthermore, remotely located computing devices could be remotely connected to networks via a modem and a temporary communication link. In essence, network 103 may include virtually any communication technology by which information may travel between computing devices. Additionally, in the various embodiments, the communicated information may include virtually any kind of information including, but not limited to processor-readable instructions, data structures, program modules, applications, raw data, control data, archived data, video data, voice data, image data, text data, and the like.

Network 102 may be partially or entirely embodied by one or more wireless networks. A wireless network may include any of a variety of wireless sub-networks that may further overlay stand-alone ad-hoc networks, and the like. Such sub-networks may include mesh networks, Wireless LAN (WLAN) networks, Wireless Router (WR) mesh, cellular networks, pico networks, PANs, Open Air Laser networks, Microwave networks, and the like. Network 102 may further include an autonomous system of intermediate network devices such as terminals, gateways, routers, switches, firewalls, load balancers, and the like, which are coupled to wired and/or wireless communication links. These autonomous devices may be operable to move freely and randomly and organize themselves arbitrarily, such that the topology of network 102 may change rapidly.

Network 102 may further employ a plurality of wired and wireless access technologies, e.g., 2nd (2G), 3rd (3G), 4th (4G), 5th (5G) generation wireless access technologies, and the like, for mobile devices. These wired and wireless access technologies may also include Global System for Mobile communication (GSM), General Packet Radio Services (GPRS), Enhanced Data GSM Environment (EDGE), Code Division Multiple Access (CDMA), Wideband Code Division Multiple Access (WCDMA), Long Term Evolution Advanced (LTE), Universal Mobile Telecommunications System (UMTS), Orthogonal frequency-division multiplexing (OFDM), Wideband Code Division Multiple Access (W-CDMA), Code Division Multiple Access 2000 (CDMA2000), Evolution-Data Optimized (EV-DO), High-Speed Downlink Packet Access (HSDPA), IEEE 802.16 Worldwide Interoperability for Microwave Access (WiMax), ultra wide band (UWB), user datagram protocol (UDP), transmission control protocol/Internet protocol (TCP/IP), any portion of the Open Systems Interconnection (OSI) model protocols. Short Message Service (SMS), Multimedia Messaging Service (MMS), Web Access Protocol (WAP), Session Initiation Protocol/Real-time Transport Protocol (SIP/RTP), or any of a variety of other wireless or wired communication protocols, in one non-limiting example, network 102 may enable a mobile device to wirelessly access a network service through a combination of several radio network access technologies such as GSM, EDGE, SMS, HSDPA, LTE and the like.

### Enclosure of Blade Servers

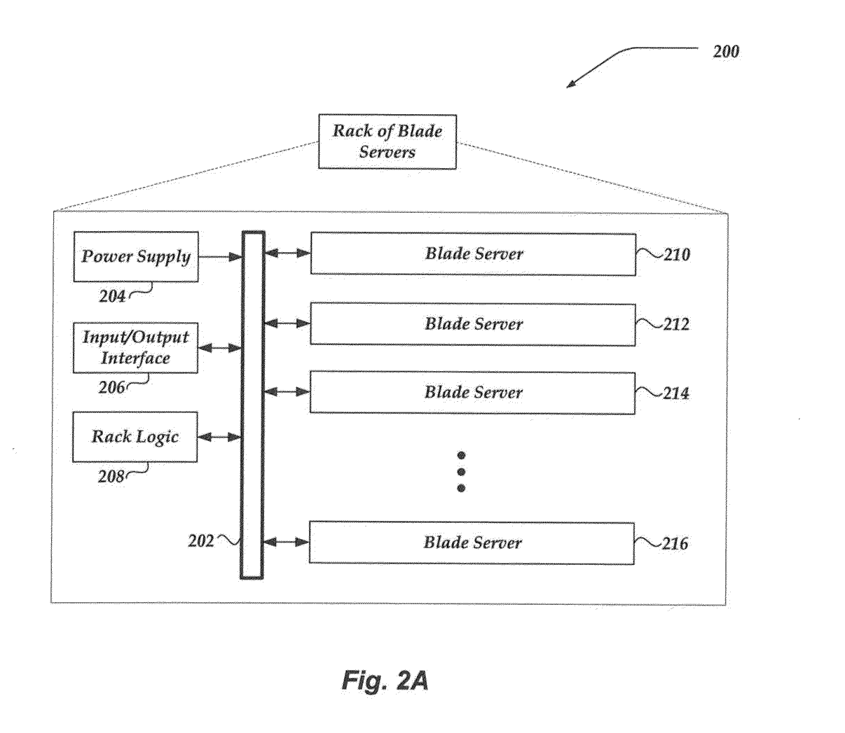

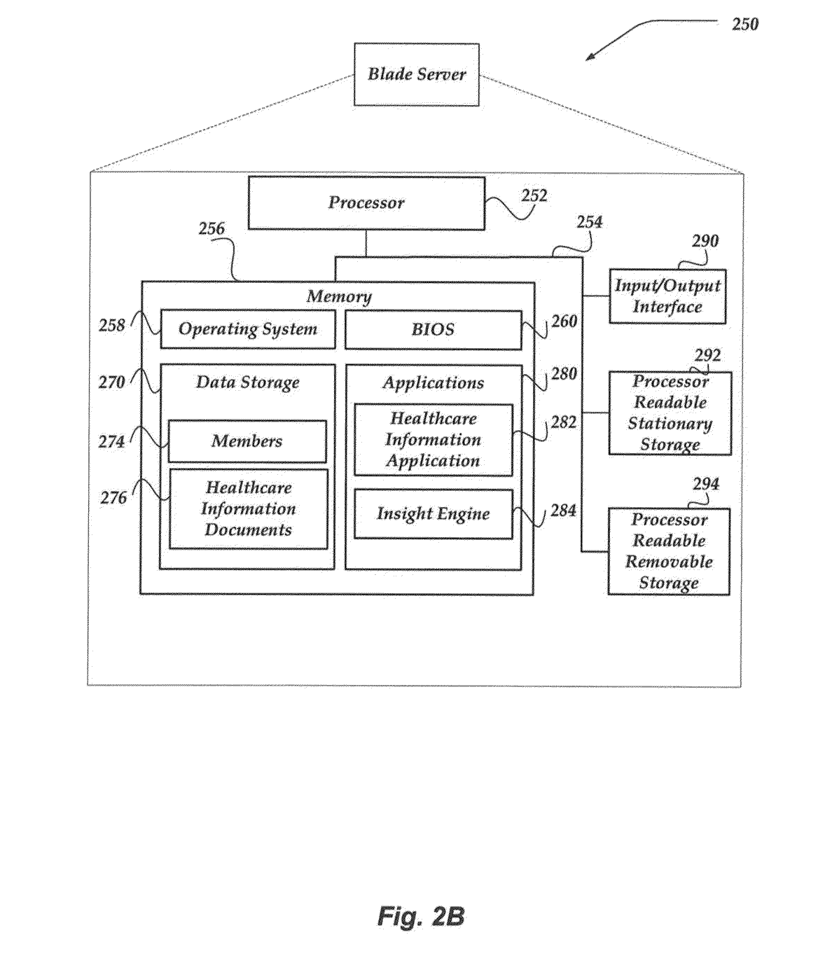

FIG. 2A shows one embodiment of an enclosure of blade servers 200, which are also illustrated in FIG. 1. Enclosure of blade servers 200 may include many more or fewer components than those shown in FIG. 2A. However, the components shown are sufficient to disclose an illustrative embodiment. Generally, a blade server is a stripped down server computing device with a modular design optimized to minimize the use of physical space and energy. A blade enclosure can include several blade servers and provide each with power, cooling, network, interfaces, input/output interfaces, and resource management. Although not shown, an enclosure of server computers typically includes several computers that merely require a network connection and a power cord connection to operate. Each server computer often includes redundant components for power and interfaces.

As shown in the figure, enclosure 200 contains power supply 204, and input/output interface 206, rack logic 208, several blade servers 210, 212, 214, and 216, and backplane 202. Power supply 204 provides power to each component, and blade server within the enclosure. The input/output interface 206 provides internal and external communication for components and blade servers within the enclosure. Backplane 208 can enable passive and active communication of power, logic, input signals, and output signals for each blade server.

### Illustrative Blade Server

FIG. 2B illustrates an illustrative embodiment of blade server 250, which may include many more or fewer components than those shown. As shown in FIG. 2A, a plurality of blade servers may he included in one enclosure that shares resources provided by the enclosure to reduce size, power, and cost.

Blade server 250 includes processor 252 which communicates with memory 256 via bus 254. Blade server 250 also includes input/output interface 290, processor-readable stationary storage device 292, and processor-readable removable storage device 204, input/output interface 290 can enable blade server 250 to communicate with other blade servers, mobile devices, network devices, and the like. Interface 290 may provide wireless and/or wired communication links for blade server. Processor-readable stationary storage device 292 may include one or more devices such as an electromagnetic storage device (hard disk), solid state hard disk (SSD), hybrid of both an SSD and a hard disk, and the like. In some configurations, a blade server may include multiple storage devices. Also, processor-readable removable storage device 294 enables processor 252 to read non-transitive storage media for storing and accessing processor-readable instructions, modules, data structures, and other forms of data. The non-transitive storage media may include Flash, drives, tape media, floppy media, and the like.

Memory 256 may include Random Access Memory (RAM), Read-Only Memory (ROM), hybrid of RAM, and ROM, and the like. As shown, memory 256 includes operating system 258 and basic input/output system (BIOS) 260 for enabling the operation of blade server 250. In various embodiments, a general-purpose operating system may be employed such as a version of UNIX, LINUX™, a specialized server operating system, such as Microsoft's Windows Server™ and Apple Computer's IoS Server™, or the like.

Memory 256 further includes one or more data storage 270, which can be utilized by blade server 250 to store, among other things, applications 280 and/or other data. Data stores 270 may include program code, data, algorithms, and the like, tor use by processor 252 to execute and perform actions. In one embodiment, at least some of data store 270 might also be stored on another component of blade server 250, including, but not limited to, processor-readable removable storage device 294, processor-readable stationary storage device 292, or any other processor-readable storage device (not shown). Data storage 278 may include, for example, members 274, healthcare information documents 276, or the like.

Applications 280 may include processor executable instructions which, when executed by blade server 250, transmit, receive, and/or otherwise process messages, audio, video, and enable communication with other networked computing devices. Examples of application programs include database servers, file servers, calendars, transcoders, and so forth. Applications 280 may include, for example, healthcare information application 282, and insight engine 284.

Human Interface components (not pictured), may be remotely associated with blade server 250, which can enable remote input to and/or output from blade server 250. For example, information to a display or from a keyboard can be routed through the input/output interface 290 to appropriate peripheral human interface components that are remotely located. Examples of peripheral human interface components include, but are not limited to, an audio interface, a display, keypad, pointing device, touch interface, and the like.

### Illustrative Mobile Device

FIG. 3 shows one embodiment of mobile device 300 that may include many more or less components than those shown. Mobile device 300 may represent, for example, at least one embodiment of mobile devices shown in FIG. 1.

Mobile device 300 includes processor 302 in communication with memory 304 via bus 328. Mobile device 300 also includes power supply 330, network interface 332, audio interface 356, display 350, keypad 352, illuminator 354, video interface 342, input/output interface 338, haptic interface 364, global positioning systems (GPS) receiver 358. Open air gesture interface 360, temperature interface 362, camera(s) 340, projector 346, pointing device interface 366, processor-readable stationary storage device 334, and processor-readable removable storage device 336. Power supply 330 provides power to mobile device 300. A rechargeable or non-rechargeable battery may be used to provide power. The power may also be provided by an external power source, such as an AC adapter or a powered docking cradle that supplements and/or recharges the battery. And in one embodiment, although not shown, a gyroscope may be employed within mobile device 300 to measuring and/or maintaining an orientation of mobile device 300.

Mobile device 300 may optionally communicate with a base station (not shown), or directly with another computing device. Network interface 332 includes circuitry for coupling mobile device 300 to one or more networks, and is constructed for use with one or more communication protocols and technologies including, but not limited to, protocols and technologies that implement any portion of the Open Systems Interconnection (OSI) model for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GFRS), Web Access Protocol (WAP), ultra wide band (UWB), IEEE 802.16 Worldwide Interoperability for Microwave Access (WiMax), Session Initiation Protocol/Real-time Transport Protocol (SIP/RTP), General Packet Radio Services (GPRS), Enhanced Data GSM Environment (EDGE), Wideband Code Division Multiple Access (WCDMA), Long Term Evolution Advanced (LTE), Universal Mobile Telecommunications System (UMTS), Orthogonal frequency-division multiplexing (OFDM), Code Division Multiple Access 2000 (CDMA2000), Evolution-Data Optimized (EV-DO), High-Speed Downlink Packet Access (HSDPA), or any of a variety of other wireless communication protocols. Network interface 332 is sometimes known as a transceiver, transceiving device, or network interface card (NIC).

Audio interface 356 is arranged to produce and receive audio signals such as the sound of a human voice. For example, audio interface 356 may be coupled to a speaker and microphone (not shown) to enable telecommunication with others and/or generate an audio acknowledgement for some action. A microphone in audio interlace 356 can also be used for input to or control of mobile device 300, e.g., using voice recognition, detecting touch based on sound, and the like.

Display 350 maybe a liquid crystal display (LCD), gas plasma, electronic ink, light emitting diode (LED), Organic LED (OLED) or any other type of light reflective or light transmissive display that can be used with a computing device. Display 350 may also include a touch interface 344 arranged to receive input from, an object such as a stylus or a digit from a human hand, and may use resistive, capacitive, surface acoustic wave (SAW), infrared, radar, or other technologies to sense touch and/or gestures. Projector 346 may be a remote handheld projector or an integrated projector that is capable of projecting an image on a remote wall or any other reflective object such as a remote screen.

Video interface 342 may be arranged to capture video images, such as a still photo, a video segment, an infrared video, or the like. For example, video interface 342 may be coupled to a digital video camera, a web-camera, or the like. Video interface 342 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 352 may comprise any input device arranged to receive input from a user. For example, keypad 352 may include a push button numeric dial, or a keyboard. Keypad 352 may also include command buttons that are associated with selecting and sending images. Illuminator 354 may provide a status indication and/or provide light. Illuminator 354 may remain active for specific periods of time or in response to events. For example, when illuminator 354 is active, it may backlight the buttons on keypad 352 and stay on while the mobile device is powered. Also, illuminator 354 may backlight these buttons in various patterns when particular actions are performed, such as dialing another mobile device. Illuminator 354 may also cause light sources positioned within a transparent or translucent ease of the mobile device to illuminate in response to actions.

Mobile device 300 also comprises input/output, interface 338 for communicating with external peripheral devices or other computing devices such as other mobile devices and network devices. The peripheral devices may include an audio headset, display screen glasses, remote speaker system, remote speaker and microphone system, and the like. Input/output interface 338 can utilize one or more technologies, such as Universal Serial Bus (USB), Infrared, WiFi, WiMax, Bluetooth™, and the like. Haptic interface 364 is arranged to provide tactile feedback to a user of the mobile device. For example, the haptic interlace 364 may be employed to vibrate mobile device 300 in a particular way when another user of a computing device is calling. Temperature interface 362 may be used to provide a temperature measurement input and/or a temperature changing output to a user of mobile device 300. Open air gesture interface 360 may sense physical gestures of a user of mobile device 300, for example, by using single or stereo video cameras, radar, a gyroscopic sensor inside a device held or worn by the user, or the like. Camera 340 may boused to track physical eye movements of a user of mobile device 300.

GPS transceiver 358 can determine the physical coordinates of mobile device 300 on the surface of the Earth, which typically outputs a location as latitude and longitude values. GPS transceiver 358 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of mobile device 300 on the surface of the Earth. It is understood that under different conditions, GPS transceiver 358 can determine a physical location for mobile device 300. In at least one embodiment however, mobile device 300 may, through other components, provide other information that may be employed to determine a physical location of the device, including for example, a Media Access Control (MAC) address, IP address, and the like.

Human interface components can be peripheral devices that are physically separate from mobile device 300, allowing for remote input and/or output to mobile device 300. For example, information routed as described here through human interface components such as display 350 or keyboard 352 can instead he routed through network interface 332 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a mobile device with, such peripheral human interlace components is a wearable computing device, which might include a remote pico projector along with one or more cameras that remotely communicate with a separately located mobile device to sense a user's gestures toward portions of an image projected by the pico projector onto a reflected surface such as a wall or the user's hand.

A mobile device may include a browser application that is configured to receive and to send web pages, web-based messages, graphics, text, multimedia, and the like. The mobile device's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 304 may include Random Access Memory (RAM), Read-Only Memory (ROM), and/or other types of memory. Memory 304 illustrates an example of computer-readable storage media (devices) for storage of information such as computer-readable instructions, data structures, program modules or other data. Memory 304 stores a basic input/output system (BIOS) 308 for controlling low-level operation of mobile device 300. The memory also stores an operating system 306 for controlling the operation of mobile device 300. It will be appreciated that this component may include a general-purpose operating system such as a version of UNIX, or LiNUX™, or a specialized mobile computer communication operating system such as Windows Mobile™, or the Symbian® operating system. The operating system may include, or interface with a Java virtual machine module that enables control of hardware components and/or operating system, operations via Java application programs.

Memory 304 further includes one or more data storage 310, which can be utilized by mobile device 300 to store, among other things, applications 320 and/or other data. For example, data storage 310 may also be employed to store information that describes various capabilities of mobile device 300. The information may then be provided to another device based on any of a variety of events, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by a processor, such as processor 302 to execute and perform actions. In one embodiment, at least some of data storage 310 might also be stored on another component of mobile device 300, including, but not limited to, non-transitory processor-readable removable storage device 336, processor-readable stationary storage device 334, or even external to the mobile device.

Applications 320 may include computer executable instructions which, when executed by mobile device 300, transmit, receive, and/or otherwise process instructions and data. Applications 320 may include, for example, healthcare information application 322. Other examples of application programs include calendars, search programs, email client applications, IM applications, SMS applications, Voice Over Internet Protocol (VOIP) applications, contact managers, task managers, transcoders, database programs, word processing programs, security applications, spreadsheet, programs, games, search programs, and so forth.

### Illustrative Network Device

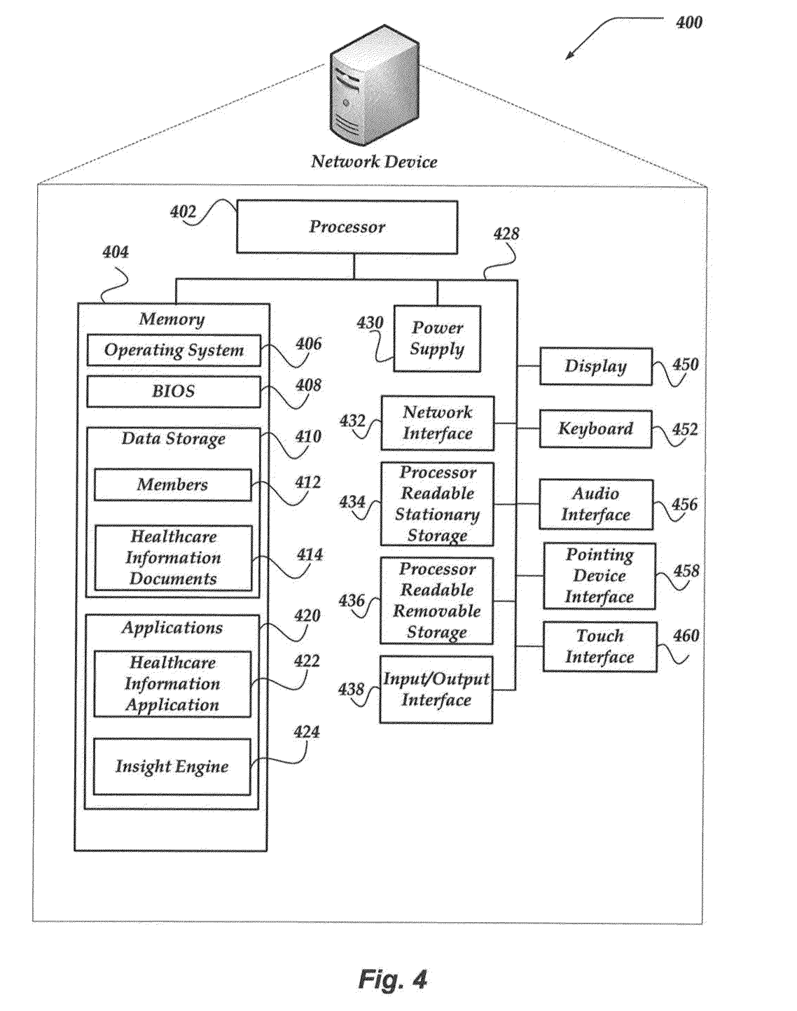

FIG. 4 shows one embodiment of network device 400 that may be included in a system implementing the invention. Network device 400 may include many more or less components than those shown in FIG. 4. However, the components shown are sufficient to disclose an illustrative embodiment for practicing the present invention. Network device 400 may represent, for example, one embodiment of at least one of health information server 112, social networking server 114, or 120 of FIG. 1.

As shown in the figure, network device 400 includes a processor 402 in communication with a memory 404 via a bus 428. Network device 400 also includes a power supply 430, network interface 432, audio interface 456, display 450, keyboard 452, input/output interface 438, processor-readable stationary storage device 434, and processor-readable removable storage device 436. Power supply 430 provides power to network device 400.

Network interface 432 includes circuitry for coupling network device 400 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram, protocol (UDP), transmission control protocol/Internet protocol (TCP/IP), Short Message Service (SMS), Multimedia Messaging Service (MMS), general packet radio service (GPRS), WAP, ultra wide band (UWB), IEEE 802.16 Worldwide Interoperability tor Microwave Access (WiMax), Session Initiation Protocol/Real-time Transport Protocol (SIP/RTF), or any of a variety of other wired and wireless communication protocols. Network, interface 432 is sometimes known as a transceiver, transceiving device, or network interface card (NIC). Network device 400 may optionally communicate with a base station (not shown), or directly with another computing device.

Audio interface 456 is arranged to produce and receive audio signals such as the sound of a human voice. For example, audio interface 456 may be coupled to a speaker and microphone (not shown) to enable telecommunication with, others and/or generate an audio, acknowledgement, for some action. A microphone in audio interface 456 can also be used for input to or control of network device 400, for example, using voice recognition.

Display 450 may be a liquid crystal display (LCD), gas plasma, electronic ink, light emitting diode (LED), Organic LED (OLEP) or any other type of light reflective or light transmissive display that can be used with a computing device. Display 450 may he a handheld projector or pico projector capable of projecting an image on a wall or other object.

Network device 400 also may also comprise input/output interface 438 for communicating with external devices not shown in FIG. 4. Input/output interface 438 can utilize one or more wired or wireless communication technologies, such as USB™, Firewire™, WiFi, WiMax, Thunderbolt™, Infrared, Bluetooth™, Zigbee™, serial port, parallel port, and the like.

Human interface components can be physically separate from network device 400, allowing for remote input and/or output to network device 400. For example, information routed as described here through human interface components such as display 450 or keyboard 452 can instead be routed through the network interface 432 to appropriate human interface components located elsewhere on the network. Human interface components include any component that allows the computer to take input from, or send output to, a human user of a computer.

Memory 404 may include Random Access Memory (RAM), Read-Only Memory (RDM), and/or other types of memory. Memory 404 illustrates an example of computer-readable storage media (devices) for storage of information such as computer-readable instructions, data structures, program modules or other data. Memory 404 stores a basic input/output system (BIOS) 408 for controlling low-level operation of network device 400. The memory also stores an operating system 406 for controlling the operation of network device 400. It will be appreciated that this component may include a general-purpose operating system such as a version of UNIX, or LINUX™, or a specialized operating system such as Microsoft Corporation's Windows® operating system, or the Apple Corporation's IOs® operating system. The operating system may include, or interface with a Java virtual machine module that enables control of hardware components and/or operating system operations via Java application programs.

Memory 404 further includes one or more data storage 410, which can be utilized by network device 400 to store, among other things, applications 420 and/or other data. For example, data storage 410 may also be employed to store information that describes various capabilities of network device 400. The information may then be provided to another device based on any of a variety of events, including being sent as part of a header during a communication, sent upon request, or the like. Data storage 410 may also be employed to store social networking information including address books, buddy lists, aliases, user profile information, or the like. Data stores 410 may further include program code, data, algorithms, and the like, for use by a processor, such, as processor 402 to execute and perform actions. In one embodiment, at least some of data store 410 might also he stored on another component of network device 400, including, but not limited to, non-transitory media inside processor-readable removable storage device 430, processor-readable stationary storage device 434, or any other computer-readable storage device within network device 400, or even external to network device 400. Data storage 410 may include, for example, members 412, healthcare information documents 414, or the like.

Applications 420 may include computer executable instructions which, when executed by network device 400, transmit, receive, and/or otherwise process messages (e.g., SMS, Multimedia Messaging Service (MMS), Instant Message (IM), email, and/or other messages), audio, video, and enable telecommunication with another user of another mobile device. Other examples of application programs include calendars, search programs, email client applications, IM applications, SMS applications. Voice Over Internet Protocol (VOIP) applications, contact managers, task managers, transcoders, database programs, word processing programs, security applications, spreadsheet programs, games, search programs, and so forth. Applications 420 may include, for example, healthcare information application 422, and insight engine 424.

In at least one of the various embodiments, the HIS enables people join as members having varied roles and intentions related to healthcare. In at least one of the various embodiments, individuals join a HIS for a variety of reasons including, they are suffering from an illness, receiving medical treatment, members may be parents and guardians of others with health problems, or the like. Also, doctors, medical researchers, healthcare providers, family care givers, or the like, may become members of the HIS because they are treating member patients. In at least one of the various embodiments, members may be enabled to receive up to date information, regarding the patient data, treatment outcomes, medical research, or the like. Further, in at least one of the various embodiments, still others may become members because they were invited by member patients. In at least one of the various embodiments, even those with an interest in healthcare and/or medical issues may join even though they are not indirectly or directly involved with a member patient.

In at least, one of the various embodiments, a member may join the HIS for one reason and remain a part of the community after resolving their initial reason for membership. For example, a person may join as a member patient because they are receiving treatment for a medical issue and then after resolving the medical issue they may remain an active member taking part as a community member sharing their personal experience and insights with others. Likewise, in at least one of the various embodiments, a person may join the HIS in the role of a supportive community member and then become a member patient if they are required to seek treatment for an illness. In at least one of the various embodiments, one or more roles of patient, provider, care giver, care circle member, family member, community member, or the like, may be adopted depending on a user's individual circumstances at a given point in time.

In at least one of the various embodiments, new member patients may register with the HIS by supplying the basic information for their profile, such as, username, password, first name, last name, physical address, email address, gender, birthday, or the like. In at least one of the various embodiments, new members may be verified by one or more, verification methods, in at least one of the various embodiments, the HIS may send an email to each new member that enables the new member to reply to the email to activate their member profile. In at least one of the various embodiments, other verification methods could be employed, such as, sending a personal identification number (PIN) or password, to the new member via regular mail, accepting encrypted security tokens or certificates provided by trusted third-party systems (e.g., Google Health, MS Health Vault), or the like.

In at least one of the various embodiments, a member's HIS profile may be updated by additional member supplied data, such, as, height, weight, occupation, ethnicity, or the like.

In at least one of the various embodiments, members that have registered and activated their member profile may add personal health and treatment information to their profile. In at least one of the various embodiments, this information may be entered by the member by way of a user interface, such as, a mobile device application, a web browser, or the like.

In at least one of the various embodiments, member supplied information may include uploading documents, emails, articles, or the like. In at least one of the various embodiments, the members healthcare information may be imported from other sources such as, healthcare information exchanges, healthcare providers, health insurance providers, or the like.

In at least one of the various embodiments, relevant healthcare information may be imported from, patient controlled health, records (PCHR), electronic health records (EHR), electronic medical records (EMR), patient health records (PHR), and the like. In at least one of the various embodiments, healthcare information may be imported using well-known medical record exchange standards, such as, Health Level Seven International Clinical Document Architecture (HL7 CDA), (Continuity of Care Records (CCR), Continuity of Care Documents (CCD), or the like. Also, in at least one of the various embodiments, custom software modules maybe employed to import health and treatment data from non-standard, and/or propriety information sources.

In at least one of the various embodiments, the HIS may enable members to organize then profiles and their healthcare information. In at least one of the various embodiments, the HIS may be arranged to enable members to organize their profile and healthcare information by enabling the use of folders, lists, categories, labels, or the like. Also, in at least one of the various embodiments, the HIS may provide one or more predefined organization elements, such as, folders, lists, categories, labels, or the like, for use by members. Additionally, in at least one of the various embodiments, the HIS may enable members to create their own folders, lists, categories, labels, or the like.

In at least one of the various embodiments, the HIS may collect information about how members interact with the HIS. In at least one of the various embodiments, the HIS may track and/or accumulate data, and meta-data relating to the areas of the HIS that members visit. Also, in at least one of the various embodiments, the HIS may track the subject and type of information and events that, members read or interact with, such as, notifications, messages, requests, information reports, articles, or the like.

In at least one of the various embodiments, the HIS may be arranged to enable one or more members to save and organize documents, such as, research studies, web pages, notes, patient experiences, or the like, into one or more personal electronic binders.

In at least one of the various embodiments, documents may be digitally stored into a member's personal electronic binder and/or they may be associated by reference. In at least one of the various embodiment, associated documents may be in shared storage and utilized by one or more members.

In at least one of the various embodiments, annotations or other notes made by a member relating to a shared, document may be assigned a security level that may control who can see the member's notes and/or annotations for a shared document. Also, for at least one of the various embodiments, some annotations and notes maybe designated as public enabling all members to see them. In at least one of the various embodiments, annotation and notes may be restricted to member's social network, or to the member's care team. Further, in at least one of the various embodiments, a member may be enabled to assign and adjust security and access rules for accessing the various documents. In at least one of the various embodiments, documents associated with a member's binder may be organized and grouped into tiers and levels relating to subject matter, sensitivity, security access, or the like.

Additionally, for at least one of the various embodiments, access to selected documents in a member's electronic binder may be restricted to the member's care team. While other documents in the member's binder may be assigned to tiers or access levels indicating that everyone in the members social networks may view the documents.

In at least one of the various embodiments, documents, messages, reports, or the like, may be recommended and/or referred to a member based on information stored in anchor associated with the member's personal electronic binder.

Also, for at least one of the various embodiments, the HIS may be arranged to automatically update documents that are stored or associated with a member's personal electronic binder. For example, in at least one of the various embodiments, if a document in a member's personal electronic binder may be updated by the author, the HIS may notify the member that the document has been updated and/or update the document in the member's personal electronic binder. Also, in at least one of the various embodiments, the HIS may enable older versions of updated documents to may remain accessible to members for future reference.

In at least one of the various embodiments, members with activated profiles may start receiving notifications, messages, reports, information, or the like, that may be determined by the healthcare information system to be relevant to the member's interests. In at least one of the various embodiments, the notifications, messages, reports, or information may he selected by the HIS based on in part on the structured and unstructured data in a member's profile.

For example, in at least one of the various embodiments, a member that has indicated an his or her profile that he or she is being treated for asthma may begin receiving information relevant to asthma suffers. Also, in at least one of the various embodiments, members may select subject matter areas that they may be interested in tracking. In at least one of the various embodiments, the HIS may suggest candidate subject areas for tracking based on the member's profile and usage history.

In at least one of the various embodiments, the HIS may determine if information, may be relevant to a member based on in part the data in the member profile and the usage history of the member's interaction with the HIS. For example, in at least one of the various embodiments, a member that often searches the HIS documents for information about asthma may receive notification if new information related to asthma, such as, articles, reports, or the like, may discovered by the HIS.

In at least one of the various embodiments, the HIS may present information to the member if the information is determined to be relevant. In at least one of the various embodiments, the HIS may employ a variety of methods for determining the quality of relevancy for documents in the HIS.

Likewise, in at least one of the various embodiments, the HIS may employ a variety of well known methods to display the relevant information, to the member, such as, live-streams, Really Simple Syndication (RSS), hyperlinks, or the like. In at least, one of the various embodiments, the HIS may incorporate member interaction, such as, mouse clicks, ratings, bookmarking, article selection, or the like, into the process for determining the relevancy of information.

In at least one of the various embodiments, the HIS may enable members to send requests to other members to join their social network. In at least one of the various embodiments, members may identify others to send requests to join by searching among the current membership using a variety methods, such as, searching by user name, location, treatment, tags, key words, or the like. In at least one of the various embodiments, invitees may he chosen from the results of searching. Or, a prospective social network member -may be chosen by entering in their unique profile name, email address, or the like.

In at least one of the various embodiments, the HIS may enable members to send invitations to individuals who are not members using a variety of mechanisms, such as, SMTP email, third-party social networks (e.g., Facebook, Twitter direct messages, LinkedIn, or the like), mobile device text messages, or the like.

In at least one of the various embodiments, from the point of view of a member, there maybe at least two HIS social networks. In at least one of the various embodiments, the HIS social networks may be differentiated by the level of trust between fee member and the other members in the HIS social network. In at least one of the various embodiments, the HIS may define the most trusted HIS social network as the member's care circle. In at least one of the various embodiments, the care circle HIS social network (e.g., “care communities”) may include immediate family members, health care providers, close Mends, care givers, or the like.

In at least one of the various embodiments, the HIS may enable members to define other HIS social networks that may he include less trusted persons. For example, in at least one of the various embodiments, these HIS social networks may include members with whom they have a medical condition or other healthcare circumstances in common (e.g., “condition communities”).

In at least one of the various embodiments, the HIS may enable members to create social networks. Invitations to join a member's non-trusted social network may be sent to those with similar medical conditions and treatments as the member or to those members who are friends and care givers of other members having similar ailments, or to members who are just interested in similar issues as the inviting member, or the like.

In at least one of the various embodiments, the HIS may enable a member to establish social network level privacy and security settings for each of the social networks he or she participates in.

For example, in at least one of the various embodiments, the care circle social network may comprise trusted family members and close friends so a member might establish privacy rules having few restrictions to enable care circle social network members to view details in the patient profile that may be considered personal and private such as sensitive healthcare information (SHI), protected healthcare information (PHI), or the like. Other social networks may be less trusted and have other members that are not as well known the member as those in the care circle social network. Accordingly, members of less trusted social networks such as community level social networks may not be allowed access to personal and sensitive information.

In at least one of the various embodiments, in addition to the social network level privacy settings, the HIS may enable members to expand or restrict access to their profiles on an individual basis. Likewise, in at least one of the various embodiments, individual items or documents that are associated with the member's profile may have privacy access expanded or restricted on an individual item basis.

In at least one of the various embodiments, a particular document that has been uploaded into a member's profile may be designated as private for everyone except the member that uploaded the document, or it may be designated as private for one or more groups of people, or it may be designated private to some networks, or it may be designated private to some types of users, or the like.

In at least one of the various embodiments, if a member receives notification of a request to join a social network they may choose to accept, ignore, or refuse the invitation. If they accept or refuse the invitation they may be able to enter or attach a message that may be received by the member that sent the invitation.

In at least one of the various embodiments, members may use their HIS social networks in to assist them with their medical issues. For example, in at least one of the various embodiments, members may provide unstructured text based status updates regarding treatments, health outcomes, or the like.

In at least one of the various embodiments, the HIS may enable status updates to be visible to others in the member's social networks as per the privacy policy established for each network. In at least one of the various embodiments, the HIS may enable members to employ HIS social networks to alert other members by way of structured messages regarding entries made by the patient relating to treatment efficacy, mood, pain levels, or the like. In at least one of the various embodiments, social network members may be automatically notified of status updates, which may relieve the member from having to update each member of the network individually.

In at least one of the various embodiments, members of a social network may receive notifications and messages regarding the status and treatment of other members in the social network. Also, they may receive notifications regarding events that have occurred related to the symptoms, disease, treatment plan, or the like, of member patients in their social networks. For at least one of the various embodiments, if new information, such as a new research paper related to the member patients' illness may be collected by the healthcare information system, notifications may be sent to everyone in the member patient's social networks.

In at least one of the various embodiments, social network members may be alerted to the new research, paper and begin studying it. And, then they may report back to the patient member if they believe that the paper is worthy of closer review.

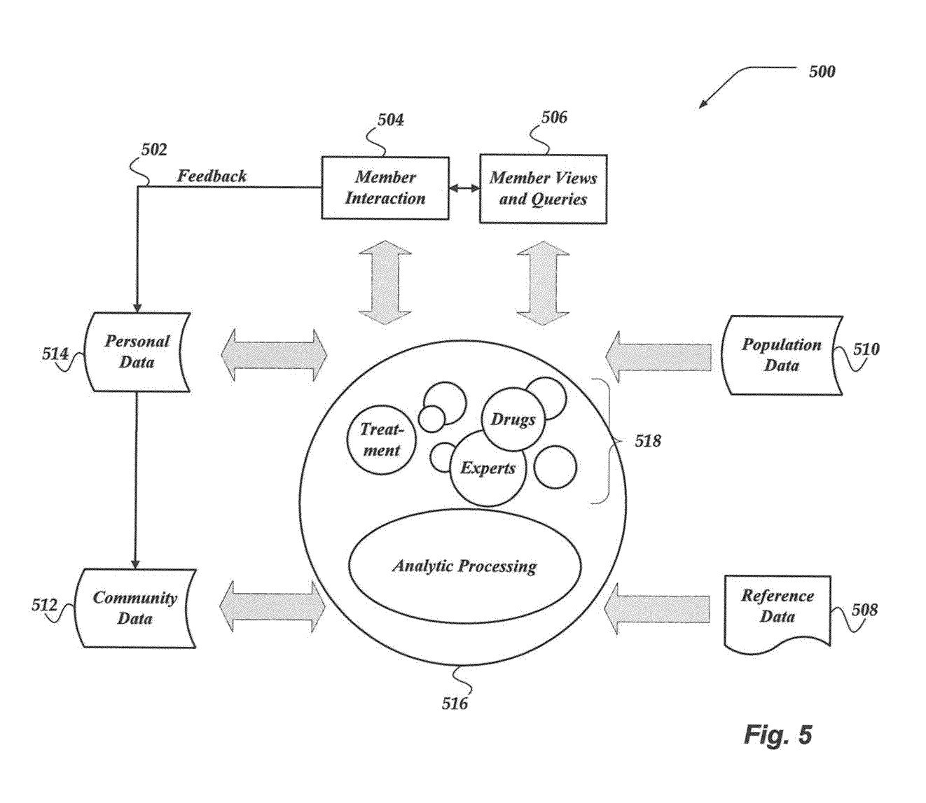

FIG. 5 shows a illustrative logical diagram of system 500 where healthcare information is collected from various sources and combined with member interactions with further analytic processing to identify insights 518 in accordance with at least one of the various embodiments.

In at least one of the various embodiments, the HIS may import healthcare information documents from a variety of available sources. In at least one of the various embodiments, the HIS may process the collected healthcare information and may determine relationships between large disjointed data sets to using insight engine 516 to identify insights 518 by determining relationships among and between the documents in ways that maybe meaningful to members.

In at least one of the various embodiments, the analytics processes that identify the relationships between collected healthcare information documents may take into account how members of the HIS use, view, share, and/or value the collected documents and corresponding insights provided by the healthcare information system. In at least one of the various embodiments, feedback paths 502 may flow from Member Interaction block 504 and Member View block 506 into data sources providing member and community interaction to feedback into the HIS.

In at least one of the various embodiments, the HIS may classify the information sources may be into at least four general categories that may be related to the type and origin of the healthcare information source.

In at least one of the various embodiments, healthcare information may be collected from reference data sources 508. In at least one of the various embodiments, reference data sources 508 may include articles, documents, and data, from government, universities, reference manuals, journals, medical reports, published articles, websites, or the like.

In at least one of the various embodiments, reference data sources may include the Food and Drug Administration, National Library of Medicine, Center for Disease Control, Wikipedia, Pharmaceutical Companies, or the like. It should be appreciated that in addition to text documents, in at least one of the various embodiments, reference data 508 may include a variety of media formats, such as, images, audio (podcasts), video, graphical, or the like. In at least one of the various embodiments, a common characteristic of this category of information is that the data is often de-identified to remove healthcare information that may he used to identify an individual patent or person.

In at least one of the various embodiments, healthcare information may be collected from population data sources that may be classified as population data 510. In at least one of the various embodiments, population data 510 may be provided from public and private healthcare information providers In at least one of the various embodiments, such documents may include reports, journals, study data, demographic information, disease registries, donor registries, human genome projects, health insurance companies, or the like. For example, in at least one of the various embodiments, population data 510 may be collected from Medline, ClinicalTrials.gov, private and public health insurers like the Centers for Medicaid and Medicare Services (CMS), private hospitals and public electronic medical/health record (EMR & HER) systems, healthcare transaction clearing houses, regional and national health information exchanges (RHIN & NHINs), health insurance exchanges, or the like.

In at least one of the various embodiments, information and/or data collected from, these sources may include raw data sets and/or normalized data sets from scientific studies, large collections of historical data, or the like. In at least one of the various embodiments, population data often includes de-identified healthcare information.

Also, in at least one of the various embodiments, healthcare information may be information may be classified as community data 512 that may fee collected based on the activity of members. In at least one of the various embodiments, community data 512 may be based on at least a portion of the historical usage of registered members, such as, searches, queries, page views, comments, blogs posts, rating of treatments, review of articles, referral to experts, social network relationships, or the like. In at least one of the various embodiments, community data 512 may be employed by the HIS to produce insights 518 that may be provided to members. In at least one of the various embodiments, the information associated with, community data 512 may be anonymous and/or de-identified.

In at least one of the various embodiments, the HIS may collect community healthcare information, from sources outside the HIS. For example, in at least one of the various embodiments, members may identify outside sources for the HIS to collect data. In at least one of the various embodiments, these sources may include other social networks, personal email, instant messaging systems, or the like, in at least one of the various embodiments, the HIS may collect data from these outside sources by employing various well-known techniques, including APIs provided by the outside data source, custom APIs, or the like.

Also, in at least one of the various embodiments, members may identity other sources of information, that may be collected by the HIS, such as, websites, RSS feed, blogs, podcasts, or the like. In at least one of the various embodiments, the HIS may recognize that members have identified these healthcare information sources and automatically pull their contents into community data 512 as part of the healthcare information collection process.

In at least one of the various embodiments, another class of healthcare information collected by the HIS may include personal data 514. In at least one of the various embodiments, personal data 514 may include data associated with the registered members, some of whom may be patient or represent patients. In at least one of the various embodiments, this may include Personal Protected Information, (PHI), Sensitive Healthcare information (SHI), Individually Identifying Healthcare information (IIHI), or the like.

In at least one of the various embodiments, personal data 514 may include data that ma be manually entered into HIS by individual members. Also, in at least one of the various embodiments, personal data 514 may include data entered by others such as, health providers, care givers, parents, guardians, or the like.

In at least one of the various embodiments, the HIS may interface with automated information systems to collect Electronic Medical Records (EMR), Electronic Health Records EBR), Personally Controlled Heath Records (PCHR), or the like. For example, in at least one of the various embodiments, an individual member's healthcare information may be collected from government and private healthcare information sources, such as, Microsoft HealthVault™, Quest Diagnostics™, Medicare™, and Blue Cross/Blue Shield™, or the like. In at least one of the various embodiments, personal and private healthcare information may be acquired either manually or electronically as directed by the member.

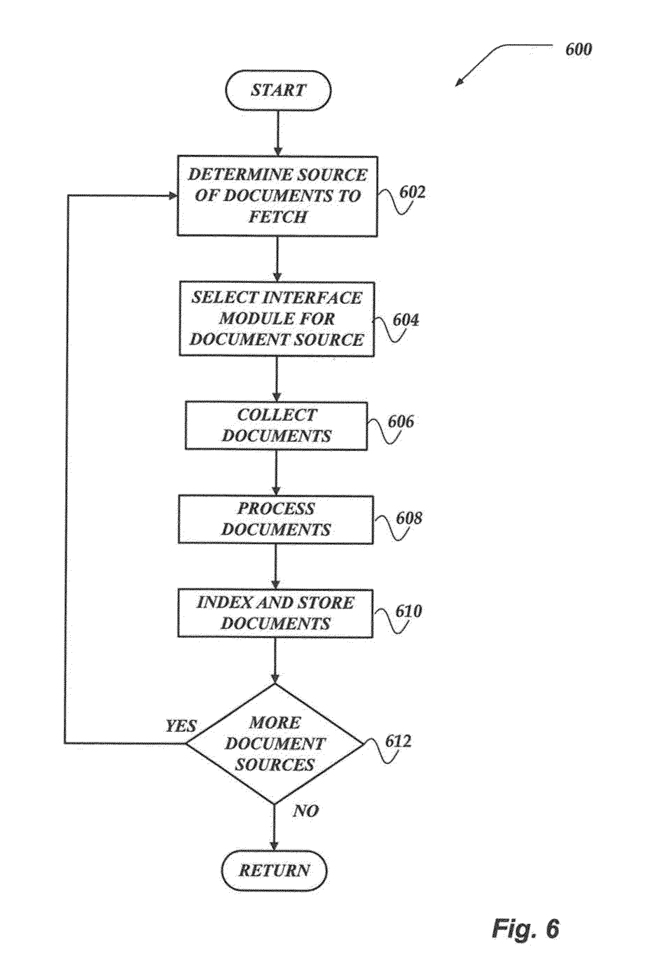

FIG. 6 shows an overview flowchart, for process 600 for collecting healthcare information documents from multiple sources, in accordance with at least one of the various embodiments.

In at least one of the various embodiments, the HIS may collects healthcare information documents from multiple sources. In at least one of the various embodiments, the HIS maybe configured to collect data from a plurality of sources, in at least one of the various embodiments, the collection process, may be initiated in a variety of ways, including, pre-planned periodic intervals (cron jobs), event driven triggers (e.g., internal processes, user behavior, and the like), aging of previously collected data, or the like.

After a start, at block 602, in at least one of the various embodiments, a healthcare information source maybe determined from the set of available healthcare information sources, each source may be selected based on a predefined configuration and/or a user may manually intervene and determine the healthcare information source.

At block 604, in at least one of the various embodiments, the interface module that supports a communication protocols and/or application interfaces that maybe supported by the targeted healthcare information source may be selected. In at least one of the various embodiments, this may include standards based electronic data interchange (EDI), including but not limited to, ANSI X12, UN/EDIFACT, xCBL, SOAP, RFC, or the like. Also, in at least one of the various embodiments, in the event that non-standard EDI is required, the HIS may employ custom, hardware: and/or software modules to communicate and collect data from the healthcare information sources requiring non-standard interfaces.

At block 606, in at least one of the various embodiments, the documents may be collected. In at least one of the various embodiments, the HIS may collect documents by employing network based protocols, including, HTTP, HTTPS, SSL, FTP, SFTP, UDP, or the like. In at least one of the various embodiments, the HIS may-employ well-know techniques to cryptographically secure the document collection process and/or communication channel.

In at least, one of the various embodiments, the HIS may be arranged to collect documents from a web server by employing a web-spider process to crawl the websites and collect documents. In at least one of the various embodiments, the HIS may include a specialized script process that may be used to collect the documents from the healthcare information source.

In at least one of the various embodiments, the HIS may employ non-network processes to collect documents. For example, in at least one of the various embodiments, healthcare information documents may be supplied in bulk on various forms of processor readable non-transitory storage media, such as, CD-ROM disks, DVD disks, BLU-RAY disks, FIREWIRE storage devices, USB storage devices, THUNDERBOLT storage devices, FLASH memory drives, hard drives, magnetic tape, networked file systems, or the like. In this case, in at least one of the various embodiments, the HIS may employ well known techniques for reading in the healthcare information documents directly from the digital storage media.

At block 608, in at least one of the various embodiments, the collected documents may be processed. In at least one of the various embodiments, the HIS may process the documents using a single step or multiple steps. For example, in at least one of the various embodiments, the HIS may employ document processing operations at many points during the operation of the HIS. In at least one of the various embodiments, the HIS may generate/extract data based on the source and content of the documents being processed, in at least one of the various embodiments, the HIS may parse a text document to identify the publisher(s), authors, treatments discussed, symptoms, side-effects, health care outcomes, drugs, geographical information, or the like.

Further, in at least one of the various embodiments, to help identify the relevance of a document the HIS may scan and parse unstructured parts of documents to systematically discover conclusion statements, outcomes, or the like, to identify the “bottom line” outcome from the document. In at least one of the various embodiments, the outcome statements of the documents may be extracted and indexed in a data store for later presentation to members.

Also, in at least one of the various embodiments, the HIS may enable members to navigate to the determined outcome statements while the document is being viewed. In at least one of the various embodiments, the HIS user-interface may provide a hyperlink, or other similar linking mechanism, to enable members to quickly navigate to the outcome statements in a document. Additionally, in at least one of the various embodiments, the HIS may enable the outcome statements to be viewed separately, having user-interface elements that enable source documents to be viewed by interested members as needed.

In at least one of the various embodiments, the HIS may match extracted terms to a variety of reference data sets, including, medical glossaries, practitioner guides, nursing references, medical dictionaries, or the like. In at least one of the various embodiments, this may enable the matched terms to be highlighted within viewed documents for providing definitions of the matched terms in context as a document is viewed. Additionally, for at least one of the various embodiments, user-interface techniques such as, popup windows, tooltips, sidebars, or the like, may be used to provide a member rapid access to definitions and/or associations for the matched terms.

At block 610, in at least one of the various embodiments, the HIS may index and store the collected documents. In at least one of the various embodiments, the HIS may utilize a portion of the information extracted from the documents to index the documents. In at least one of the various embodiments, the documents may be indexed using multiple indexing systems each suited for accessing the documents in different ways and dimensions. One skilled in the art will appreciate that multiple indexes of varying types may be generated from documents and the extracted data.

At decision block 612, in at least one of the various embodiments, if there may be more document sources to collect healthcare information from, control may loop back to block 602. Otherwise, in at least one of the various embodiments, control may be returned to a calling process.

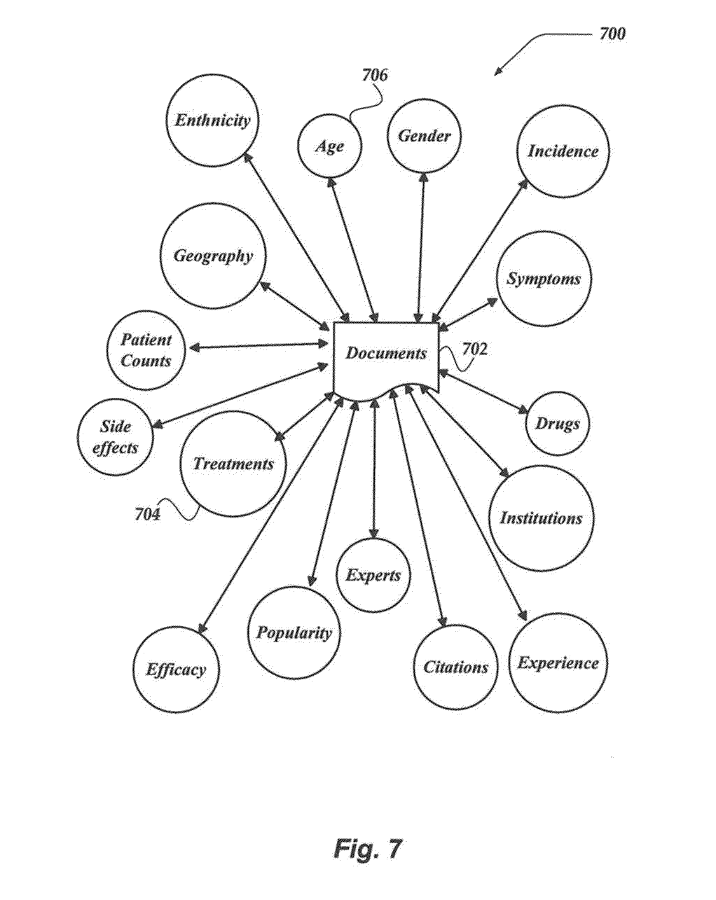

FIG. 7 illustrates extracting insights 700 from healthcare information document(s) 700 in accordance with at least one of the various embodiments. In at least one of the various embodiments, the HIS processes collected healthcare information documents to extract insights based on the extracted data, document contents, related document contents, or the like. For at least one of the various embodiments, if document 702 includes information about a particular treatment the HIS may associate the document with one or more treatments 704. Likewise, if document 702 includes references to treatments for a particular age group the HIS may associate document 702 with corresponding age groups 706. In at least one of the various embodiments, these associations may be used by the HIS to improve members' insight into how the subject matter of a given document relates to their individual circumstances.

In at least one of the various embodiments, members may search for insights using treatment views, expert views, symptom views, or the like. In at least one of the various embodiments, from each view a member may be enabled to identify documents that may be relevant to his or her circumstances. One of ordinary skill in the art will appreciate that the insights and relationships extracted from healthcare information documents are not limited to those described herein.

In at least one of the various embodiments, search results may be presented to members using a variety of visual formats, such as, bubble charts, column charts, time series, trees and graphs, sellable lists, or the like. In at least one of the various embodiments, search results may be shown in multiple formats providing the searching member with multiple views of the search results.

In at least one of the various embodiments, the various views of the search results may be presented using a dynamic user-interface that may enable the searching member to observe results as search parameters are modified. Also, in some search results views, related but different factors may be represented using simultaneously displayed search result views.

For example, in at least one of the various embodiments, a member may search for information about an illness, such as asthma, that may return multiple search, result views. One view may show recent studies grouped by authors or originating institutions, and another view may show treatments grouped by patient demographic information such as gender and age, or the like. In at least one of the various embodiments, simultaneously providing multiple views of the same result set, where the view may be oriented around different, factors enables the searching member to rapidly gain additional insight into complex information that may be returned by the search.

In at least one of the various embodiments, a member may search for information about a specific treatment for an illness that generated multiple views that if viewed in combination give the member a more accurate representation of the efficacy of the treatment.

For example, in at least one of the various embodiments, the HIS may employ one view of the search results to show that in most clinic trials the treatment was very effective. But, another view of the same result set may show that the demographics of the trial subjects are dissimilar from the patient the searching member is caring for. In at least this way, simultaneous multiple views of the same search result set may reduce the time it takes for a member for a member to identify potentially effective treatments.

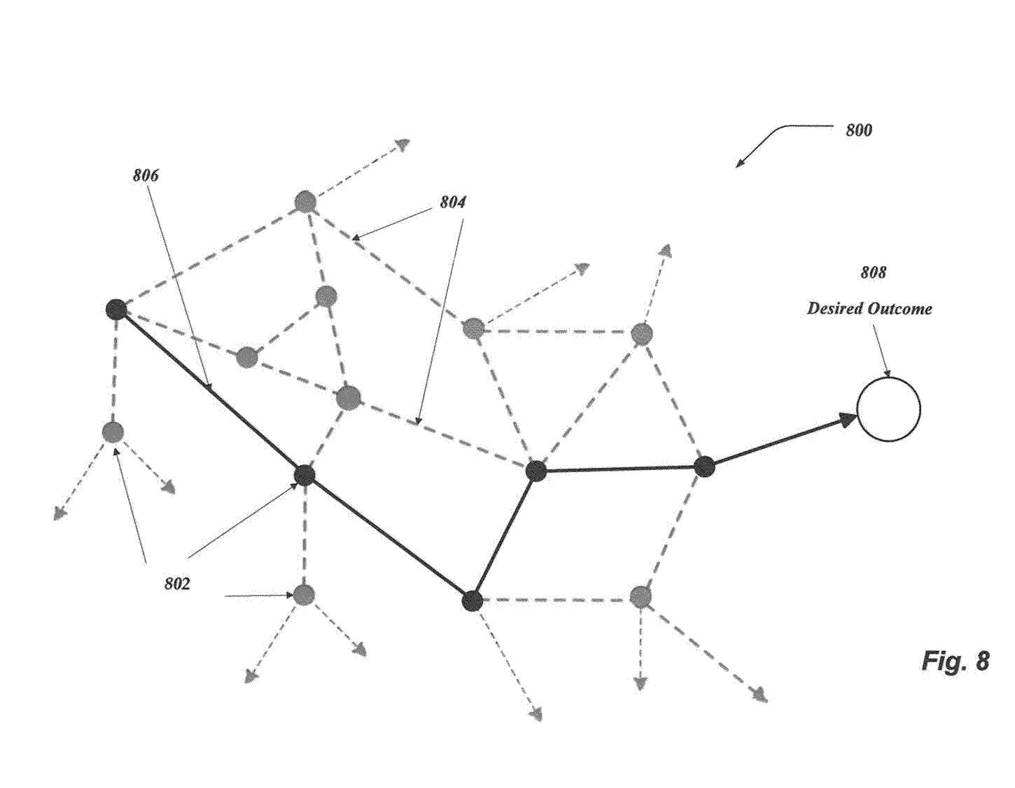

FIG. 8 illustrates a visualization of historical treatment plans arranged to help a member determine a roadmap for treatment in accordance with at least one of the various embodiments.

In at least one of the various embodiments, healthcare information data may be processed and arranged so treatment plan decisions and events may be represented as network graph 800. In at least one of the various embodiments, data used to generate network graph 800 may include healthcare information collected from outside the HIS as well as member community supplied information.

In at least one of the various embodiments, the treatment plan data in the HIS maybe include data that has been aggregated, normalized, grouped, filtered, sealed, or the like, as needed to effectively present the data to the members, as well as manage the data within the healthcare information system.

In at least one of the various embodiments, the HIS may process the collected healthcare information to identify historical treatment decision points and events 802 that may have occurred during the treatment of a particular illness or disease. Based in part on these identified points, the healthcare information system may generate a data structure such as network graph 800 with the treatment decision points and events representing vertices of the graph. It should be appreciated that there are numerous data structures that may be employed by various embodiments to represent the historical treatment data and the connections between the various treatments and outcomes.

In at least one of the various embodiments, a member may use historical treatment plans 804 from other patients to provide insight into the efficacy of his or her treatment plan 806. The HIS may generate network graph 800 so that the vertices may be significant points in past treatment plans and the edges are the paths between the treatment points. For example, if a patient is diagnosed with an illness, such as asthma, the time of diagnosis may represent the first point on the network graph. In at least one of the various embodiments, many patients diagnosed with asthma may start at the same treatment point. However, once a patient is diagnosed, with an illness there maybe many events, actions, and decisions that happen over the course of treatment.

In at least one of the various embodiments, each decision and event related to a member's treatment may be indicated by a vertex on network-graph 800. In at least one of the various embodiments, historical treatment plans 804 may be arranged and displayed the enable the member to see and visualise the steps, or choices made by past patients.

In at least one of the various embodiments, the information may be arranged to indicate the number of patients the made the same decision or had the same event occur as part of their treatment plan, in at least one of the various embodiments, the information may he indicated in network graph 800 using colors, shapes, size of shapes, or the like. Also, in at least one of the various embodiments, these user-interface elements may be used to indicate how often a particular option was chosen, how satisfied the patients were with the decision, or the like. in at least one of the various embodiments, by being enabled to view the potential choices in a graphical visualization, the member may be able to see the subsequent choices made by other members of the population in context with other available choices.

In at least one of the various embodiments, representing treatment plans using network graph 800 where the vertices may be treatment plan decision points or treatment plan events may enable members and/or their healthcare providers to gauge how an individual treatment plan may be progressing. In at least one of the various embodiments, network graph 800 may enable comparisons between treatment paths to be made in context, with historical treatment plans derived from collected healthcare information and member community interaction.

In at least one of the various embodiments, the HIS may be enabled to analyze a member patient's treatment plan and discover other historical treatment plans that may closely match the member patient's current treatment plan. In at least one of the various embodiments, the member may identity useful insights by reviewing the historical treatment plans mat closely match the member patient's own plan.

In at least one of the various embodiments, the HIS may employ various techniques to find the closely matched historical treatment plans, including pattern, matching, path matching, graph matching, or the like.

In at least one of the various embodiments, historical data in combination with real-time data may be employed to predict future outcomes, in at least one of the various embodiments, the HIS may determine a plurality of historical treatment plans or patterns to present to the member patient based on strength of the match between the member's treatment plan, and other treatment plans in the HIS.

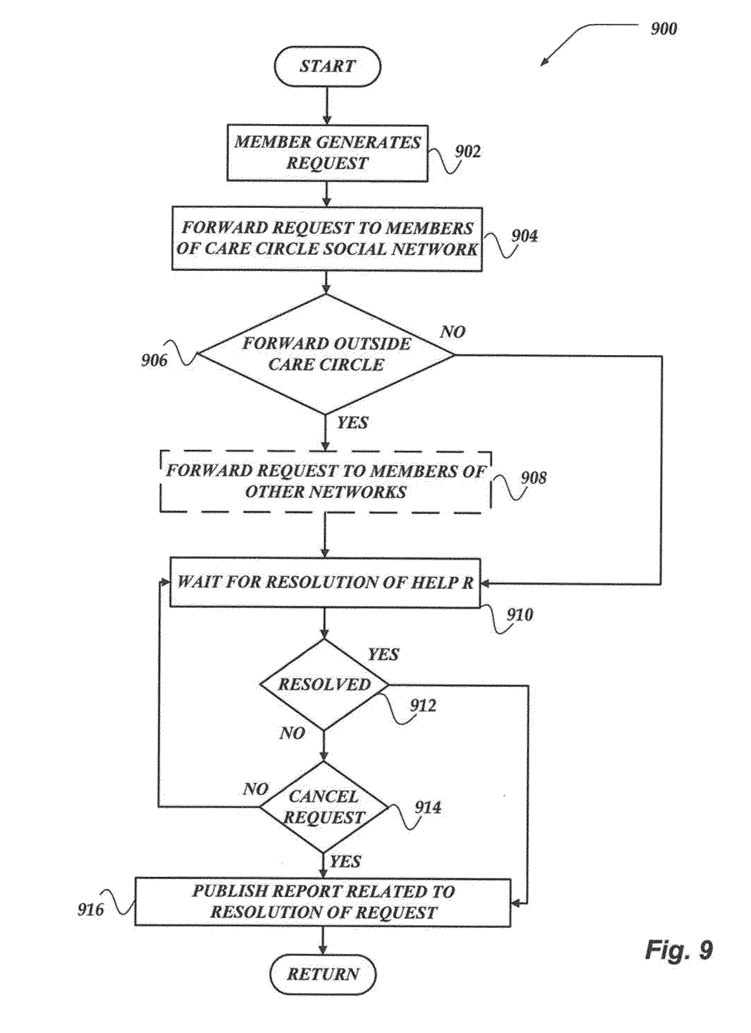

FIG. 9 shows an overview flowchart for process 900 that enables member patients to create and send requests in accordance with at least one of the various embodiments.

After a start block, at block 902, in at least one of the various embodiments, the HIS may be employed by a member to generate a request for healthcare information. In at least one of the various embodiments, the request maybe generated using a user interface operating on a variety of client devices, such as, mobile devices applications, cell phones applications, web browsers, or the like. Further, in at least one of the various embodiments, requests may be generated using messaging technologies such as SMS, MMS, email, or the like. Also, in at least one of the various embodiments, members may generate requests using the HIS social networks and/or third party social networks.

In at least one of the various embodiments, the HIS may enable the requesting member to generate a request that may include properties such as, but not limited to, classification, type, access level, priority, effective date, expiration date, or the like. Likewise, in at least one of the various embodiments, the request may include a variety of content types including, text, audio, video, attachments, hyperlinks, or the like.

Also, in at least one of the various embodiments, the HIS may enable a requesting member to configure and/or generate a form like user interface that may be included with the request. For example, in at least one of the various embodiments, a member may request help with meeting family obligations such as picking up children from school. In such a case, the HIS may enable the member to generate and send a form with the request for collecting the availability times of those members that respond to the request.

In at least one of the various embodiments, using forms may enable the requesting member get the specific help they are requesting and it may help the healthcare information system to manage the results by collecting structured offers by members when responding to the request.

In at least one of the various embodiments, the HIS may enable health professional members to create forms arranged to collect specialized data to facilitate diagnosis or treatment of member patients. These forms may be attached to or embedded into messages and requests.

In at least one of the various embodiments, requests maybe published and/or forwarded to members selected by the sender. In at least one of the various embodiments, the HIS may determine that recipients based on rule-based filters, configurations, heuristics, or the like.

In at least one of the various embodiments, the HIS may enable expert researcher members to generate specialized forms arranged for collecting data to use as part of a research study. These forms may be attached to, or embedded in requests. These requests may be published to members as selected by the sender. Also, recipients may be selected by rule based filters that may automatically identify at least a portion of the targeted audience.

At block 904, in at least one of the various embodiments, the request may first be forwarded to members designated as part of care circle social network of the user that generated the request (e.g., requesting member). In at least one of the various embodiments, the HIS may also enable the requesting member to exclude specified members of the care circle from receiving a particular request.

In at least one of the various embodiments, the HIS may enable members to generate one or more lists of recipients that, may be designated as blocked from requests generated and/or forwarded by an individual member. In at least one of the various embodiments, members may develop these exclusion lists overtime by adding and/or removing members from the lists.

In at least one of the various embodiments, the HIS may be configured to forward the users request to one or more members that may be in social networks other than the care circle.

In at least one of the various embodiments, the HIS may determine members for forwarding based at least on a determined type of relationship between the requesting user and the members selected to receive the request. In at least one of the various embodiments, the selected members may be determined based on a strength, of relationship between the requesting user and the other members.

In at least one of the various embodiments, strength of relationship may be determined based the type of relationship the user has with a given members. Relationship types may include, but are not limited to, close family, spouse, children, friends, acquaintances, business associates, physician, common interests, common illness, common treatments, or the like. In at least one of the various embodiments, each relationship type may be associated with a weighted score that may indicate the strength (e.g., importance of the relationship). In at least one of the various embodiments, the HIS may enable users to define additional, relationship types and well as defined/modify the weight value for each type.

In at least one of the various embodiments, members in the HIS may he organized using a network graph that connects the members based on their relationship and/or interests. The distance between members in such as network graph may be included in strength of relationship calculations. For example, in at least one of the various embodiments, the farther the distance (e.g., degree of separation, number of edges between two members in a graph, or the like) between members, the more the strength of relationship may be diminished.

In at least one of the various embodiments, social networks may he evaluated based on the strength of relationships of the members. For example, in at least one of the various embodiments, a social network that includes several members having strong relationships to a user (as calculated by strength of relationship) a user may be determined to be a candidate social, network for forwarding help requests.

Likewise, in at least one of the various embodiments, the HIS may evaluate relationships between two or more social networks based on the strength of relationship of the member of each respective social network. Also, in at least one of the various embodiments, the HIS may determine an aggregate strength of relationship scores for a social network based in part on the strength of relationship between individual members.

Further, in at least one of the various embodiments, social networks may be assigned scoring weights based on the type of social network. Social network types may include, close family, spouse, children, friends, acquaintances, business associates, physician, common interests, common illness, common treatments, or the like. The weights may be used for adjusting social, network strength of relationship scores. For example, in at least one of the various embodiments, members' strength of relationship scores for family type social network may be valued, more the same the strength of relationship scores for common interest type social networks.

In at least one of the various embodiments, users may define additional social network types. Also, in at least one of the various embodiments, users may define/modify the social networks scoring weights.

At decision block 906, in at least one of the various embodiments, the HIS may determine if the request may be forwarded to members outside the care circle social network. In at least one of the various embodiments, the HIS may he arranged to enable the requesting member to configure rules that automatically determine if the request may be forwarded outside of the care circle social network. In at least one of the various embodiments, the HIS may enable the requesting member to set permission and access lists at the time the request may be generated. In at least one of the various embodiments, the HIS may enable the requesting member to select whether the request should be de-identified before it is forwarded.

At block 908, in at least one of the various embodiments, optionally the HIS may also be configured to forward, the request in stages. In at least one of the various embodiments, the HIS may determine if to forward the request based on an elapsed time period. In at least one of the various embodiments, this time period may be determined based on the predefined rules, configurations, automatic priority escalations, the requesting members input, or the like. For example, in at least one of the various embodiments, one configuration may forward the request outside of the care circle social network only in the event that the request has not been resolved within a certain time period.

In at least one of the various embodiments, members may record their interests in a member profile. The HIS may analyze these predefined interests and apply them if determining the members which to forward the request In at least one of the various embodiments, if the HIS determines “interested” members it may filter them based on one or more permission rules and/or filters set by the member that initiated the request.

At block 910 in at least one of the various embodiments, the process may wait until the request has been resolved or canceled. In at least one of the various embodiments, the HIS may update the state of requests while they are pending. In at least one of the various embodiments, such updates may be employed to indicate relevant status of the request to the requesting member.

At decision block 912, in at least one of the various embodiments, if the request is resolved, control may move to block 916. Otherwise, in at least one of the various embodiments, control, may move to decision block 914.

At decision block 914, in at least one of the various embodiments, if the request may be canceled, control may move to block 916. Otherwise, in at least one of the various embodiments, control may loop back to block 912.

At block 916, in at least one of the various embodiments, the process may publish the resolution/termination status of the request to the HIS. In at least one of the various embodiments, included with the resolution status, additional, data related to the termination of the request, including, how long resolution took, which member resolved the request, which members reviewed the request, which members were forwarded the request and how they are connected to the requesting member, how long it took for the request to be resolved, or the like. In at least one of the various embodiments, if resolution information may he published and stored on the HIS, the process may return control to a calling process.

In at least one of the various embodiments, a requesting member may establish a deadline in the form of a predefined duration. In at least one of the various embodiments, if a request may be unresolved after the elapsed time since the request was generated exceeds a predefined duration the request may be canceled.

In at least one of the various embodiments, the HIS may be arranged to enabling requests to be forwarded based on the social network receipt members may be part of in at least one of the various embodiments, the HIS may generate temporary social networks based on the direction and/or preferences of the requesting members. For example, in at least one of the various embodiments, a temporary social network maybe defined as including the members of a user's family social network less one individual for which the request may be inappropriate.

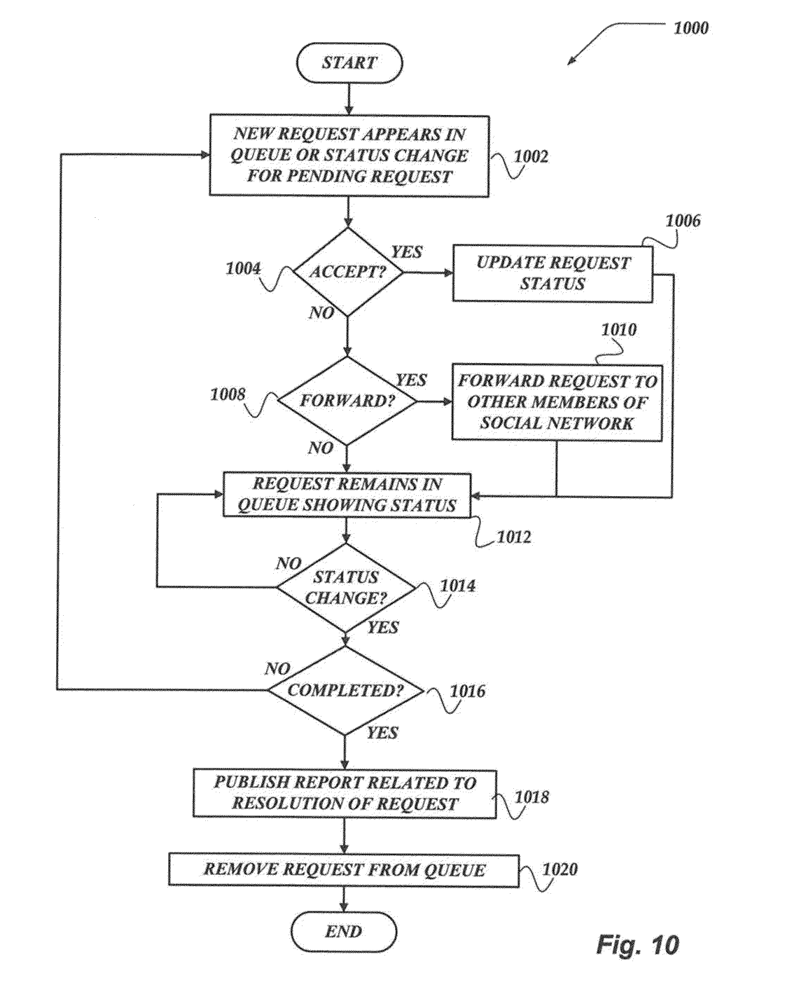

FIG. 10 shows a flowchart for process 1000 for receiving and responding to requests from members in accordance with at least one of the various embodiments.

After a start block, at block 1002, in at least one of the various embodiments, the HIS may be configured to forward requests to qualifying members. In at least one of the various embodiments, if one or more requests maybe available, a member may receive an indication from the HIS that there is a pending request.

In at least one of the various embodiments, the HIS may employ various methods to notify the member of the pending request. In at least one of the various embodiments, notification methods may include SMS, MMS, email, automated telephone calls, electronic calendar notifications or alarms, user interface based indicators, or the like,

In at least one of the various embodiments, the HIS may enable a member to configure rule based filters that may be applied to pending requests. In at least one of the various embodiments, the filters may be configured to determine if and/or how a member may be notified of pending requests.

At decision block 1004, in at least one of the various embodiments, if the member accepts the request, control may move to block 1006. Otherwise, in at least one of the various embodiments, control may move to decision block 1008.

At block 1006, in at least one of the various embodiments, the HIS may collect information, from the member and update the status of the request. For example, in at least one of the various embodiments, the request may be configured to indicate that it has been accepted. In at least one of the various embodiments, some requests may be configured to invite-multiple, members to accept the request simultaneously.

At decision block 1008, in at least one of the various embodiments, if the member chooses to forward the request to other members control may move to block 1010. Otherwise, in at least one of the various embodiments, control may move to block 1012.

At block 1010, in at least one of the various embodiments, the HIS may be employed to forward the request to other members. In at least one of the various embodiments, the HIS may enable the member to select members unknown to the original requesting member. Likewise, in at least one of the various embodiments, the HIS may enable a requesting member to put restrictions on how and to whom the request may be forwarded.

In at least one of the various embodiments, the HIS may be arranged to de-indentify the request if it is forwarded based in part on the request attributes. In at least one of the various embodiments, the request attributes may includes lists and/or reference to members may be qualified and/or disqualified to receive a forwarded request. In at least one of the various embodiments, the HIS may enable a member to forward the request to members outside of the HIS by employing email, SMS, interfaces to third party social networks, or the like.

In at least one of the various embodiments, individuals who receive a forwarded request may be enabled to forward the request to their own HIS communities and networks, personal social networks, email lists, or the like, extending the reach of the requesting member's request.

Also, in at least one of the various embodiments, the HIS may be arranged to enable a member accept a request and then to forward it to other members as well. In at least one of the various embodiments, this may he enabled if a request invites more than one member to accept it. For example, in at least one of the various embodiments, a request that includes a request for transportation to a clinic for a treatment appointment may enable two members' to join in the resolution of the request—one for the ride to the clinic and the other for the ride home from the clinic. Thus, a person that accepts the “ride to the clinic” may be inclined to forward the request to other members that may be willing to provide a “ride from the clinic.”

At block 1012, in at least one of the various embodiments, the HIS may store the request in a queue enabling members to follow the progress and/or the status of the forwarded request. In at least one of the various embodiments, the HIS may enable a member to decide to accept a request that he or she had previously forwarded if the request remains unresolved.

In at least one of the various embodiments, the HIS may update the status of the pending request. In at least one of the various embodiments, updates may indicate that a pending request has been accepted by another user, the request is about to expire, the priority of the request has been increased or decreased, the request has been resolved, or the like.

At decision block 1014, if the status of the pending request has changed, control may move to decision block 1016. Otherwise, in at least one of the various embodiments, control may loop back to block 1012.

At decision block 1016, in at least one of the various embodiments, if the request may be resolved and/or terminated,, control may move to block 1018. Otherwise, in at least one of the various embodiments, control may loop back to block 1002. In at least one of the various embodiments, unresolved requests maybe resubmitted to the member. In at least one of the various embodiments, resubmitting the request may trigger additional notifications and reminders to the member.

In at least one of the various embodiments, the HIS may enable the member to reconsider their actions with respect the pending request if the status of the request has changed. For example, a member may have ignored, or forwarded the request when it first appeared in his or her queue, then later, the priority of the request may have increased. Now the member may decide to accept the request based on it having a higher priority.

At block 1018, in at least one of the various embodiments, the HIS may publish the resolution status of the request. In at least one of the various embodiments, additional information regarding the termination of the request may be published and/or stored, such information may include, how much time elapsed before resolution, the identify of members that participated in the resolution of the request, the identity of the members that reviewed the request, the identity of the members that were forwarded the request and how they are connected to the requesting member, or the like.

At block 1020, in at least one of the various embodiments, the request may be removed from the member's request queue. In at least one of the various embodiments, the HIS may be arranged to enable the member to archive requests so they may be reviewed at a later date. Next, in at least one of the various embodiments, control may be returned to a calling process.

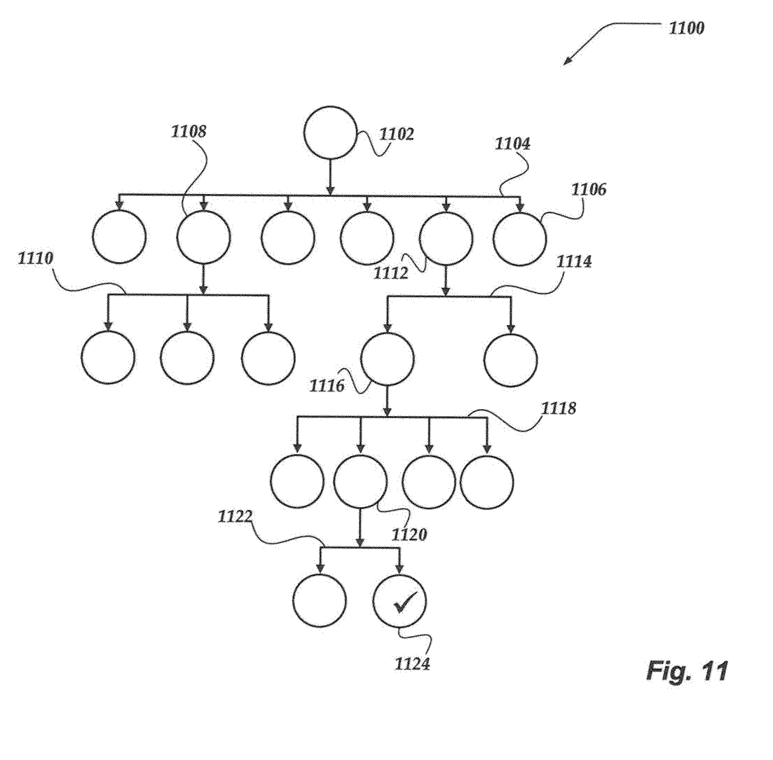

FIG. 11 illustrates social network path to action 1100 for a request in accordance with one of the various embodiments. In at least one of the various embodiments, the HIS may generate a report in the form of path to action 1100 based in part on the interactions between the members and request in at least one of the various embodiments, path to action 1100 may show how a request flows through the member community.

For example, in at least one of the various embodiments, member 1102 may generate a request that may initially send the request to social network 1106. In at least one of the various embodiments, member 1106, member 1108, and member 1112 maybe illustrative of members associated with social network 1106. In at least one of the various embodiments, member 1108 may forward the request to social network 1110. Likewise, in at least one of the various embodiments, member 1112 may forward the request to social network 1114.

Continuing with this example, in at least one of the various embodiments, member 1116 may further forward the request to the members associated with social network 1118. Next, member 1120 may again forward the request to social network 1122. To complete this example, in at least one of the various embodiments, member 1124 may terminate the request by resolving the request.

Thus, for this example, using path to action 1100, the termination path for the request may be seen as starting with member 1102. Next, the request was forwarded by 1112. Then picked up and forwarded by member 1116. Again, the request was forwarded to member 1124 where it was resolved. (e.g., member 1102→member 1112→member 1116→member 1120→member 1124).

In at least one of the various embodiments, the HIS may track the course that a request takes as it works it way through the HIS (e.g., the path-to-action). In at least one of the various embodiments, one of the final steps in processing a member's request may be to store the data related to the termination (e.g., resolution or non-resolution) of each request.

In at least one of the various embodiments, stored data may include information describing which members received the request and when they received it. Also, in at least one of the various embodiments, data, may be collected to record how a member responded to a request (e.g., accepted, ignored, and forwarded).

In at least one of the various embodiments, the HIS may employ information gathered from the request and the “path-to-action” to gain insights into about how members in the HIS communities and social, networks interact and relate to each other.

In at least one of the various embodiments, the HIS may generate one or more visualizations of the data, related to a request that show the path to action that was associated with a terminated request. In at least one of the various embodiments, this may enable members to make better informed requests in future.

Also, in at least, one of the various embodiments, the HIS may enable the requesting members to invite members shown in a request's path to action into their personal social network.

In at least one of the various embodiments, the HIS may be arranged to automatically notify members of products and services offered for sale that may be determined to be relevant, to the member. In at least one of the various embodiments, the HIS may determine the relevancy of an offer by analyzing a variety of member characteristics including member profile, treatment plans, treatment plans of social network members, social network membership, interaction history, request history, or the like. In at least one of the various embodiments, the offerings may be comprised of advertisements for third-party party vendors or direct sales. In at least one of the various embodiments, the HIS may be arranged to present the offerings in various ways, such as, embedding or incorporating the offering in a user interface, or by including the offering in messages sent, member, such, as, email, text, Chat, Instant Messaging, SMS, MMS, requests, notifications, or the like.

In at least one of the various embodiments, the HIS may enable members to give gifts toe other member by purchasing one or more offered products or services and directing the HIS to deliver the purchased offerings to another member. Likewise, in at least one of the various embodiments, members may create gift registries where they may indicate products and services that may be desired as part of their treatment plan. Other members may identify the needed products or services and purchase them for the requesting member.

In at least one of the various embodiments, the HIS may enable members to determine their insurance eligibility for various treatments. In at least one of the various embodiments, the HIS may be arranged to employ publically available information, from sources such as Medicare, Blue Cross/Blue Shield, or the like, in order to determine the insurance eligibility of treatments. Also, in at least one of the various embodiments, additional insight into insurance eligibility may be determined from data extracted from collected healthcare information documents.

Also, in at least one of the various embodiments, the HIS may be arranged to directly communicate with the member's health insurance provider to determine insurance eligibility for prospective treatments.

In at least one of the various embodiments, the HIS maybe arranged to model costs, duration, potential outcomes, or the like, for available treatment plans. In at least one of the various embodiments, a model may be implemented using the combination of insurance eligibility data, historical treatment data, reference data, community data, or the like. In at least one of the various embodiments, members may be able to examine and compare how different treatment plans may vary in terms of historical costs, projected costs, historical duration, projection duration, historical outcome, projected outcome, of the like.

Furthermore, in at least one of the various embodiments, the HIS may be arranged to enable members to provide comments that may be attached one or more of the above describe elements, such as, treatments, outcomes, patient experience, research studies, experts, institutions, or the like. In at least one of the various embodiments, comment topics may be shared with other members or with persons and networks outside of the HIS.

In at least one of the various embodiments, members and others that are authorized to access to the comments may be enabled join in the topic discussion and enter their own comments. In at least one of the various embodiments, members may be enabled to subscribe to comment topics to receive notifications if updates may be made, new comments added, or the like. In at least one of the various embodiments, the HIS may enable filter rules to be defined to help members discover comments that may be of relevance to them.

It may be understood that figures, and combinations of steps in the flowchart-like illustrations, can he implemented by computer program instructions. These program instructions maybe provided to a processor to produce a machine, such that the instructions executing on the processor create a means for implementing the actions specified in the flowchart blocks. The computer program instructions may be executed by a processor to cause a series of operational steps to be performed by the processor to produce a computer implemented process for implementing the actions specified in the flowchart block or blocks. These program instructions may be stored on some type of machine readable media, such as computer readable media and/or processor readable storage media, and the like.

What is claimed as new and desired to be protected by Letters Patent of the United States is:

1. A method for managing healthcare information between members of a social network with one or more network devices, comprising:
providing at least one request for healthcare information from at least one user to at least one member of a social network based at least on a determined type, of relationship between the at least one user and the at least one member;
enabling the at least one member to forward, the at least, one request to at least a portion of a plurality of members of at least one of a plurality of social networks, wherein the portion of the plurality of members is based on at least a determined type of relationship between, the at least one member and the portion of the plurality of members, wherein the forwarding of the at least one request is defined by at least one rule provided by the at least one user;
generating at least one path that corresponds to each, forwarding of the at least one request between each member of the at least one of the plurality of social networks; and
providing at least one report based on the at least one path to the at least one user and at least one of the plurality of members that provides a resolution to the at least one request.

2. The method of claim 1, further comprising, canceling the at least one request if a predefined period of time elapses.

3. The method of claim 1, further comprising, if the at least one request is modified by the at least one user, notifying at least those members of the at least one social network that previously received the at least one request.

4. The method of claim 1, wherein forwarding at least one request, further comprises if a predefined period of time elapses before the report is provided, providing the at least one request to at least one additional member.

5. The method of claim 1, wherein, forwarding the at least one request, further comprises, determining at least one additional member to receive the forwarded at least one request based on at least one predefined interest of the at least one additional member.

6. The method of claim 1, further comprising, determining at least one relationship between at least one social network and at least one other social network based on tracking subsequent forwarding of the request by each of their members that at least receives the request.

7. The method of claim 1, further comprising, forwarding the at least one request to at least one non-member of the at least one social network.

8. A system that is operative to manage healthcare information between members of a social network over a network, comprising:
a network device, including;
a transceiver that is operative to communicate over the network;
a memory that is operative to store at least instructions; and
a processor device that is operative to execute instructions that enable actions, including:
providing at least one request for healthcare information from at least one user to at least one member of a social network based at least on a determined type of relationship between the at least one user and the at least one member;
enabling the at least, one-member to forward the at least one request to at least a portion of a plurality of members of at least one of a plurality of social networks wherein the portion of the plurality of members is based on at least a determined type of relationship between the at least one member and the portion of the plurality of members, wherein the forwarding of the at least one request is defined by at least one rule provided by the at least one user;
generating at least one path that corresponds to each forwarding of the at least one request between each member of the at least one of the plurality of social networks; and
providing at least one report based on the at least one path to the at least one user and at least one of the plurality of members that provides a resolution to the at least one request.

9. The system of claim 8, further comprising, canceling the at least one request if a predefined period of time elapses.

10. The system of claim 8, further comprising, if the at least one request is modified by the at least one user, notifying at least those members of the at least one social network that previously received the at least one request.

11. The system of claim 8, wherein forwarding at least one request, further comprises if a predefined period of time elapses before the report is provided, providing the at least one request to at least one additional member.

12. The system of claim 8, wherein forwarding the at least one request, further comprises, determining at least one additional member to receive the forwarded at least one request based on at least one predefined interest of the at least one additional member.

13. The system of claim 8, further comprising, determining at least one relationship between at least one social network and at least one other social network based on tracking subsequent forwarding of the request by each of their members that at least receives the request.

14. The system of claim 8, further comprising, forwarding the at least one request to at least one non-member of the at least one social network.

15. A network device that is operative for managing healthcare information between members of a social network, comprising:
a transceiver that is operative to communicate over a network;
a memory that is operative to store at least instructions; and
a processor device that is operative to execute instructions that enable actions, including:
providing at least one request for healthcare information from at least one user to at least one member of a social network based at least on a determined type of relationship between the at least one user and the at least one member;
enabling the at least one member to forward the at least one request to at least a portion of a plurality of members of at least one of a plurality of social networks, wherein the portion of the plurality of members is based on at least a determined type of relationship between the at least one member and the portion of the plurality of members, wherein the forwarding of the at least one request is defined by at least one rule provided by the at least one user;
generating at least one path that corresponds to each forwarding of the at least one request between each member of the at least one of the plurality of social networks; and
providing at least one report based on the at least one path to the at least one user and at least one of the plurality of members that provides a resolution to the at least one request.

16. The network device of claim 15, further comprising, canceling the at least one request if a predefined period of time elapses.

17. The network device of claim 15, further comprising, if the at least one request is modified by the at least one user, notifying at least those members of the at least one social network that previously received the at least one request.

18. The network device of claim 15, wherein forwarding at least one request, further comprises if a predefined period of time elapses before the report is provided, providing the at least one request to at least one additional member.

19. The network device of claim 15, wherein forwarding the at least one request, further comprises, determining at least one additional member to receive the forwarded at least one request based on at least one predefined interest of the at least one additional member.

20. The network device of claim 15, further comprising, determining at least one relationship between at least one social network and at least one other social network based on tracking subsequent forwarding of the request by each of their members that at least receives the request.

21. The network device of claim 15, further comprising, forwarding the at least one request to at least one non-member of the at least one social network.

22. A processor readable non-transitive storage media that includes instructions for managing healthcare information between members of a social network, wherein execution of the instructions by a processor device enables actions, comprising:
providing at least one request for healthcare information from at least one user to at least one member of a social network based at least on a determined type of relationship between the at least one user and the at least one member;
enabling the at least one member to forward the at least one request to at least a portion of a plurality of members of at least one of a plurality of social networks, wherein the portion of the plurality of members is based on at least a determined type of relationship between the at least one member and the portion of the plurality of members, wherein the forwarding of the at least one request is defined by at least one rule provided by the at least one user;
generating at least one path that corresponds to each forwarding of the at least one request between each member of the at least one of the plurality of social networks; and
providing at least one report based on the at least one path to the at least one user and at least one of the plurality of members that provides a resolution to the at least one request.
